(19) United States
(12) Patent Application Publication
(10) Pub. No.: US 2024/0290955 A1
(43) Pub. Date: Aug. 29, 2024

(54) COATED CATHODE ACTIVE MATERIAL PARTICLES FOR LITHIUM-ION BATTERIES, CATHODE FOR LITHIUM-ION BATTERIES, METHOD OF PRODUCING COATED CATHODE ACTIVE MATERIAL PARTICLES FOR LITHIUM-ION BATTERIES, AND LITHIUM-ION BATTERY

(71) Applicant: APB CORPORATION, Chiyoda-ku Tokyo (JP)

(72) Inventors: Naoya OMAE, Kyoto-shi Kyoto (JP); Shogo ISOMURA, Kyoto-shi Kyoto (JP); Hideaki HORIE, Chiyoda-ku Tokyo (JP); Ryosuke KUSANO, Kyoto-shi Kyoto (JP); Kazuya TSUCHIDA, Kyoto-shi Kyoto (JP)

(21) Appl. No.: 18/568,833

(22) PCT Filed: Jun. 13, 2022
(86) PCT No.: PCT/JP2022/023610

§ 371 Date: Dec. 10, 2023

(30) Foreign Application Priority Data
Jun. 11, 2021 (JP) 2021-098128
Jul. 16, 2021 (JP) 2021-118045

(51) Int. Cl. H01M 4/36; H01M 4/02; H01M 4/13; H01M 4/66; H01M 10/0525

(52) U.S. Cl. CPC H01M 4/366; H01M 4/13; H01M 4/668; H01M 10/0525; H01M 2004/021; H01M 2004/028

(57) ABSTRACT

Coated electrode active material particles for lithium-ion batteries, that can suppress side reactions between the electrolytic solution and the coated electrode active materials, and that can prevent the internal resistance value of lithium-ion batteries from increasing, can be provided. The coated cathode active material particles for lithium-ion batteries in which at least a part of the surface of the cathode active material particles is coated with a coating layer, wherein the coating layer contains a polymer compound, a conductive assistant, and ceramic particles, and wherein the BET specific surface area of the ceramic particles is 70 to 300 m²/g.

### FIELD OF THE INVENTION

This invention relates to coated cathode active material particles for lithium-ion batteries, a cathode for lithium-ion batteries, a method of producing coated cathode active material particles for lithium-ion batteries, and a lithium-ion battery.

### BACKGROUND ART

Lithium-ion batteries have come to be widely used in a variety of usages as secondary batteries that can achieve high energy density and high power density. Therefore, various materials have been studied in order to develop higher performance lithium-ion batteries.

For example, a coated active material is disclosed in Patent reference 1, wherein the coated active material contains a resin composition for coated active material, which is a polymer of a monomer composition comprising an ester compound having a monovalent aliphatic alcohol with 1 to 12 carbon atoms and (meth)acrylic acid and an anionic monomer and a polymer with an acid value of 30 to 700, and wherein the coated active material has a coating layer containing the resin composition for coating active material on at least a part of the surface of the active material.

### CITATION LIST

### Patent Literature

[Patent Reference 1] Japanese Unexamined Patent Application Publication No. 2017-160294
[Patent Reference 2] Japanese Unexamined Patent Application Publication No. 2019-053877

### BRIEF SUMMARY OF THE INVENTION

### Problems that Invention is to Solve

Lithium-ion batteries have become widely used in various purposes and are sometimes used in high-temperature environments, and the like. In terms of conventional lithium-ion batteries using coated active materials, when they are used in high-temperature environments, there was a problem that side reactions occurred between the electrolytic solution and the coated active materials, causing deterioration of the lithium-ion batteries (specifically, internal resistance value may increase). Therefore, there was room for improvement.

The present invention has an objective to provide coated electrode active material particles lithium-ion batteries that can suppress side reactions between the electrolytic solution and the coated electrode active materials, and that can prevent the internal resistance value of lithium-ion batteries from increasing. The present invention also has an objective to provide a cathode for lithium-ion batteries having the coated cathode active material particles for lithium-ion batteries, and a method of producing the coated cathode active material particles for lithium-ion batteries.

### Means to Solve the Problems

As a result of further intensive studies, in order to solve the above problems, the present inventors have discovered that side reactions occurring between the electrolyte solution and coated electrode active material particles can be suppressed, and an increase in internal resistance of lithium-ion batteries can be effectively reduced by forming a coating layer, which contains a polymer compound, a conductive assistant, and ceramic particles having a certain BET specific surface area, on the surface of the cathode active material particles. This discovery has led to this invention.

In other words, the present invention is coated cathode active material particles for lithium-ion batteries in which at least a part of the surface of the cathode active material particles is coated with a coating layer, wherein the coating layer contains a polymer compound, a conductive assistant, and ceramic particles, and wherein the BET specific surface area of the ceramic particles is 70 to 300 m²/g; a cathode for lithium-ion batteries comprising the coated cathode active material particles for lithium-ion batteries mentioned above and a cathode active material layer with an electrolytic solution containing an electrolyte and a solvent, wherein the cathode active material layer consists of a non-bound component of the coated cathode active material particles for lithium-ion batteries; a method of producing coated cathode active material particles for lithium-ion batteries, wherein the coated cathode material particles for lithium-ion batteries are mentioned above, the method includes a step of removing a solvent after mixing cathode active material particles, a polymer compound, a conductive assistant, ceramic particles, and an organic solvent.

### Effects of the Invention

According to this invention, coated cathode active material particles for lithium-ion batteries, that can suppress side reactions between the electrolytic solution and the coated electrode active material particles, and that can prevent the internal resistance value of the lithium-ion battery from increasing, can be obtained.

### BRIEF DESCRIPTION OF DRAWINGS

FIG. 1 is a perspective view schematically showing an example of a cathode for lithium-ion batteries according to this invention.

FIG. 2 is a cross-sectional view along line A-A shown in FIG. 1.

### DESCRIPTION OF EMBODIMENTS

### [Coated Electrode Active Material Particles for Lithium-Ion Batteries]

According to this invention, coated cathode active material particles for lithium-ion batteries (hereinafter, also simply referred to as “coated cathode active material particles”) is coated cathode active material particles in which at least a part of the surface of the cathode active material particles is coated with a coating layer, wherein the coating layer contains a polymer compound, a conductive assistant, and ceramic particles. In terms of the coated cathode active material particles of this invention, the coating layer contains a polymer compound, a conductive assistant, and ceramic particles having a certain BET specific surface area. The ceramic particles having a certain BET specific surface area, which are contained in the coating layer, can reduce the contact area between the cathode active material particles and the electrolytic solution. As a result of this, side reactions between the electrolytic solution and the coated electrode active material particles can be suppressed, and the increase of the internal resistance value of the lithium-ion battery can be reduced.

The cathode active material particles include a composite oxide of lithium and a transition metal {a composite oxido having one kind of transition metal (LiCoO₂, LiNiO₂, LiAlMnO₄, LiMnO, LiMn₂C₄, or the like), a composite oxide having two kinds of transition metal elements (for example, LiFeMnO₄, LiNi₁₋ₓCoₓO₂, LiMn_{1-y}CO_{y}O₂, LiNi_{1/3}CO_{1/3}Al_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1, and one example is LiNi_{1/3}Mn_{1/3}Co_{1/3}O₂)], or the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive macromolecule (for example, polyaniline, polypyrrole, polythiophene, polyacetylene, poly-p-phenylene, or polyvinyl carbazole). Also, these cathode active material particles may be used alone. Two or more thereof may be used in combination. Herein, the lithium-containing transition metal phosphate may have some of the transition metal sites replaced with other transition metals.

The volume average particle size of the cathode active material particles is preferably from 0.01 to 100 μm, more preferably from 0.1 to 35 μm, and even more preferably from 2 to 30 μm, from the viewpoint of electrical characteristics of the battery.

The coating layer includes a polymer compound, a conductive assistance, and ceramic particles. The polymer compound is preferably a resin containing a polymer having the acrylic monomer (a) as an essential constituent monomer and the like. Specifically, the polymer compound constituting the coating layer is preferably a polymer of a monomer composition containing acrylic acid (a0) as the acrylic monomer (a). In terms of the above monomer composition, the content of acrylic acid (a0) is preferably 90 wt % or more and 98 wt % or less based on the weight of the entire monomer. From the point of flexibility of the coating layer, the content of acrylic acid (a0) is preferably 93.0 to 97.5 wt % based on the weight of the entire monomer, and is more preferably more 95.0 to 97.0 wt %.

As the acrylic monomer (a), the polymer compound constituting the coating layer may contain a monomer (a1) having a carboxyl group or an acid anhydride group other than acrylic acid (a0).

Examples of the monomer (a1) having a carboxyl group or an acid anhydride group other than acrylic acid (a0) are monocarboxylic acids with 3 to 15 carbon atoms such as methacrylic acid, crotonic acid, and cinnamic acid; dicarboxylic acids with 4 to 24 carbon atoms such as (anhydrous) maleic acid, fumaric acid, itaconic acid, citraconic acid, and mesaconic acid (anhydrous); Trivalent to tetravalent or higher valence polycarboxylic acids having 6 to 24 carbon atoms such as aconitic acid, etc.

The polymer compound constituting the coating layer may contain a monomer (a2) represented by the following formula (1) as the acrylic monomer (a).

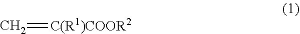

[In formula (1), R¹ is a hydrogen atom or a methyl group, and R² is a straight chain having 4 to 12 carbon atoms or a branched alkyl group having 3 to 36 carbon atoms.]

In terms of the monomer (a2) shown in formula (1), R¹ represents a hydrogen atom or a methyl group. Preferably, R¹ is a methyl group. Re is preferably a straight chain or branched alkyl group having 4 to 12 carbon atoms, or a branched alkyl group having 13 to 36 carbon atoms.

(a21) Ester Compound in which Re is a Straight Chain or Branched Alkyl Group Having 4 to 12 Carbon Atoms

Examples of the straight chain alkyl group having 4 to 12 carbon atoms include butyl group, pentyl group, hexyl group, heptyl group, octyl group, nonyl group, decyl group, undecyl group, and dodecyl group.

Examples of branched alkyl groups having 4 to 12 carbon atoms include 1-methylpropyl group (sec-butyl group), 2-methylpropyl group, 1,1-dimethylethyl group (tert-butyl group), 1-methylbutyl group, 1-dimethylpropyl group, 1,2-dimethylpropyl group, 2,2-dimethylpropyl group (neopentyl group), 1-methylpentyl group, 2-methylpentyl group, 3-methylpentyl group, 4-methylpentyl group, 1,1-dimethylbutyl group, 1,2-dimethylbutyl group, 1,3-dimethylbutyl group, 2,2-dimethylbutyl group, 2,3-dimethylbutyl group, 1-ethylbutyl group, 2-ethylbutyl group, 1-methylhexyl group, 2-methylhexyl group, 2-methylhexyl group, 4-methylhexyl group, 5-methylhexyl group, 1-ethylpentyl group, 2-ethylpentyl group, 3-ethylpentyl group, 1,1-dimethylpentyl group, 1,2-dimethylpentyl group, 1,3-dimethylpentyl group, 2,2-dimethylpentyl group, 2,3-dimethylpentyl group, 2-ethylpentyl group, 1-methylheptyl group, 2-methylheptyl group, 3-methylheptyl group, 4-methylheptyl group, 5-methylheptyl group, 6-methylheptyl group, 1,1-dimethylhexyl group, 1,2-dimethylhexyl group, 1,3-dimethylhexyl group, 1,4-dimethylhexyl group, 1,5-dimethylhexyl group, 1-ethylhexyl group, 2-ethylhexyl group, 1-methyloctyl group, 2-methyloctyl group, 3-methyloctyl group, 4-Methyloctyl group, 5-methyloctyl group, 6-methyloctyl group, 7-methyloctyl group, 1,1-dimethylheptyl group, 1,2-dimethylheptyl group, 1,3-dimethylheptyl group, 1,4-dimethylheptyl group, 1,5-dimethylheptyl group, 1,6-dimethylheptyl group, 1-ethylheptyl group, 2-ethylheptyl group, 1-methylnonyl group, 2-methylnonyl group, 3-methylnonyl group, 4-Methylnonyl group, 5-methylnonyl group, 6-methylnonyl group, 7-methylnonyl group, 8-methylnonyl group, 1,1-dimethyloctyl group, 1,2-dimethyloctyl group, 1,3-dimethyloctyl group, 1,4-dimethyloctyl group, 1,5-dimethyloctyl group, 1,6-dimethyloctyl group, 1,7-dimethyloctyl group, 1-ethyloctyl group, 2-ethyloctyl group, 1-methyldecyl group, 2-methyldecyl group, 3-methyldecyl group, 4-methyldecyl group, 5-methyldecyl group, 6-methyldecyl group, 7-methyldecyl group, 8-methyldecyl group, 9-methyldecyl group, 1,1-dimethylnonyl group, 1,2-dimethylnonyl group group, 1,3-dimethylnonyl group, 1,4-dimethylnonyl group, 1,5-dimethylnonyl group, 1,6-dimethylnonyl group, 1,7-dimethylnonyl group, 1,8-dimethylnonyl group, 1-ethylnonyl group, 2-ethylnonyl group, 1-methylundecyl group, 2-methylundecyl group, 3-methylundecyl group, 4-methylundecyl group, 5-methylundecyl group, 6-methylundecyl group group, 7-methylundecyl group, 8-methylundecyl group, 9-methylundecyl group, 10-methylundecyl group, 1,1-dimethyldecyl group, 1,2-dimethyldecyl group, 1,3-Dimethyldecyl group, 1,4-dimethyldecyl group, 1,5-dimethyldecyl group, 1,6-dimethyldecyl group, 1,7-dimethyldecyl group, 1,8-dimethyldecyl group, 1,9-dimethyldecyl group group, 1-ethyldecyl group, 2-ethyldecyl group, etc. Among these, 2-ethylhexyl group is particularly preferred.

(a22) Ester Compound in which R² is a Branched Alkyl Group Having 13 to 36 Carbon Atoms

Examples of branched alkyl groups having 13 to 36 carbon atoms include 1-alkylalkyl groups [1-methyldodecyl group, 1-butyleicosyl group, 1-hexyloctadecyl group, 1-octylhexadecyl group, 1-decyltetradecyl group, 1-undecyltridecyl group, etc.], 2-alkylalkyl group [2-methyldodecyl group, 2-hexyloctadecyl group, 2-octylhexadecyl group, 2-decyltetradecyl group, 2-undecyltridecyl group, 2-dodecylhexadecyl group, 2-tridecylpentadecyl group, 2-decyl octadecyl group, 2-tetradecyl octadecyl group, 2-hexadecyl octadecyl group, 2-tetradecyl eicosyl group, 2-hexadecyl eicosyl group groups], 3-34-alkylalkyl groups (3-alkylalkyl 4-group, alkylalkyl group, 5-alkylalkyl group, 32-alkylalkyl group, 33-alkylalkyl group, 34-alkylalkyl group, etc.), or mixed alkyl groups containing one or more branched alkyl groups, such as the residue of an oxo alcohol with the hydroxyl group removed, wherein the oxo alcohol is obtained from Propylene oligomer (7-11mer), ethylene/propylene (molar ratio 16/1-1/11) oligomer, isobutylene oligomer (7-8mer), and α-olefin (5-20 carbon atoms) oligomer (4-octamer) and the like.

The polymer compound constituting the coating layer may contain, as the acrylic monomer (a), an ester compound (a3) consisting of a monovalent aliphatic alcohol with 1 to 3 carbon atoms and (meth)acrylic acid.

Examples of the monovalent aliphatic alcohol with 1 to 3 carbon atoms constituting the ester compound (a3) include methanol, ethanol, 1-propanol, and 2-propanol.

It is noted that (meth)acrylic acid means acrylic acid or methacrylic acid.

The polymer compound constituting the coating layer is preferably a polymer of a monomer composition containing acrylic acid (a0) and at least one of monomer (a1), monomer (a2), and ester compound (a3). More preferably, the coating resin is a polymer of a monomer composition containing acrylic acid (a0) and at least one of a monomer (a1), an ester compound (a21), and an ester compound (a3). Further preferably, the coating resin is a polymer of a monomer composition containing acrylic acid (a0) and any one of monomer (a1), monomer (a2), and ester compound (a3). Most preferably, the coating resin is a polymer of a monomer composition comprising acrylic acid (a0) and any one of a monomer (a1), an ester compound (a21), and an ester compound (a3). As the polymer compound constituting the coating layer, examples include a copolymer of acrylic acid and maleic acid using maleic acid as the monomer (a1), a copolymer of acrylic acid and 2-ethylhexyl methacrylate using 2-ethylhexyl methacrylate as the monomer (a2), a copolymer of acrylic acid and methyl methacrylate using methyl methacrylate as the ester compound (a3).

From the point of suppressing volume change of anode active material particles, the total content of monomer (a1), monomer (a2) and ester compound (a3) is preferably 2.0 to 9.9% by weight, more preferably 2.5 to 7.0% by weight based on the weight of the entire monomer.

Preferably, the polymer compound constituting the coating layer does not contain, as the acrylic monomer (a), a salt (a4) of an anionic monomer having a polymerizable unsaturated double bond and an anionic group.

The structure having the polymerizable unsaturated double bond include a vinyl group, an allyl group, a styrenyl group, and a (meth)acryloyl group.

Examples of the anionic group include a sulfonic acid group and a carboxyl group.

An anionic monomer having a polymerizable unsaturated double bond and an anionic group is a compound obtained by a combination of these. Examples include vinylsulfonic acid, allylsulfonic acid, styrenesulfonic acid and (meth)acrylic acid.

Herein, (meth)acryloyl group means an acryloyl group or a methacryloyl group. Examples of the cations constituting the anionic monomer salt (a4) include lithium ions, sodium ions, potassium ions, and ammonium ions.

In addition, within the range of its physical properties, the polymer compound constituting the coating layer may contain, as the acrylic monomer (a), a radically polymerizable monomer (a5) that is copolymerizable with acrylic acid (a0), monomer (a1), monomer (a2), and ester compound (a3).

The radically polymerizable monomer (a5) is preferably a monomer that does not contain active hydrogen, and the following monomers (a51) to (a58) can be used.

(a51) Hydrocarbyl (Meth)Acrylate Constituting (Meth)Acrylic Acid and One of Straight Chain Aliphatic Monool Having 13 to 20 Carbon Atoms, Alicyclic Monool Having 5 to 20 Carbon Atoms, or Aromatic Aliphatic Monool Having 7 to 20 Carbon Atoms

The monools include (i) straight chain aliphatic monools (tridecyl alcohol, myristyl alcohol, pentadecyl alcohol, cetyl alcohol, heptadecyl alcohol, stearyl alcohol, nonadecyl alcohol, arachidyl alcohol, etc.), (ii) alicyclic monools (cyclopentyl alcohol, cyclohexyl alcohol, cycloheptyl alcohol, cyclooctyl alcohol, etc.), (iii) aromatic aliphatic monools (benzyl alcohol, etc.), and mixtures of two or more thereof.

(a52) Poly (n=2-30) Oxyalkylene (2-4 Carbon Atoms) Alkyl (1-18 Carbon Atoms) Ether (Meth)Acrylate [10 Mole Adduct (Meth)Acrylate of Ethylene Oxide (Hereinafter Abbreviated as EO) to Methanol, 10 Mole Adduct (Meth)Acrylate of Propylene Oxide (Hereinafter Abbreviated as PO) to Methanol, Etc.]
(a53) Nitrogen-Containing Vinyl Compound
(a53-1) Vinyl Compound Containing Amide Group
(i) (meth)acrylamide compounds having 3 to 30 carbon atoms, such as N,N-dialkyl (1 to 6 carbon atoms) or dialkyl (7 to 15 carbon atoms) (meth)acrylamide (N,N-dimethylacrylamide, N,N-dibenzylacrylamide, etc.), diacetone acrylamide
(ii) Vinyl compounds containing an amide group having 4 to 20 carbon atoms, excluding the above (meth)acrylamide compounds, such as N-methyl-N-vinylacetamide, cyclic amide [pyrrolidone compounds (having 6 to 13 carbon atoms, such as N-vinylpyrrolidone, etc.)]
   (a53-2) (Meth)Acrylate Compound
(i) Dialkyl (1 to 4 carbon atoms) aminoalkyl (1 to 4 carbon atoms) (meth)acrylate [N,N-dimethylaminoethyl (meth)acrylate, N,N-diethylaminoethyl (meth)acrylate, t-Butylaminoethyl (meth)acrylate, morpholinoethyl (meth)acrylate, etc.]

(ii) (meth)acrylate containing quaternary ammonium group {(meth)acrylate containing tertiary amino group [N,N-dimethylaminoethyl (meth)acrylate, N,N-diethylaminoethyl (meth)acrylate, etc.] quaternized compounds (quaternized using a quaternizing agent such as methyl chloride, dimethyl sulfate, benzyl chloride, dimethyl carbonate, etc.), etc.}

(a53-3) Vinyl Compound Containing Heterocycle

Pyridine compounds (7 to 14 carbon atoms, e.g. 2- or 4-vinylpyridine), imidazole compounds (5 to 12 carbon atoms, e.g. N-vinylimidazole), pyrrole compounds (6 to 13 carbon atoms, e.g. N-vinylpyrrole), pyrrolidone compound (6 to 13 carbon atoms, e.g. N-vinyl-2-pyrrolidone)

(a53-4) Vinyl Compound Containing Nitrile Groups

Vinyl compound containing nitrile groups having 3 to 15 carbon atoms, such as (meth)acrylonitrile, cyanostyrene, cyanoalkyl (1 to 4 carbon atoms) acrylates

(a53-5) Vinyl Compound Containing Other Nitrogen Vinyl compound containing nitro group (8 to 16 carbon atoms, such as nitrostyrene), etc.
(a54) Vinyl Hydrocarbon
(a54-1) Aliphatic Vinyl Hydrocarbon

Olefins having 2 to 18 carbon atoms or more (ethylene, propylene, butene, isobutylene, pentene, heptene, diisobutylene, octene, dodecene, octadecene, etc.), dienes having 4 to 10 carbon atoms or more (butadiene, isoprene, 1,4-pentadiene, 1,5-hexadiene, 1,7-octadiene, etc.) etc.

(a54-2) Alicyclic Vinyl Hydrocarbon

Cyclic unsaturated compounds having from 4 to 18 carbon atoms or more, such as cycloalkenes (e.g. cyclohexene), (di) cycloalkadienes [e.g. (di) cyclopentadiene], terpenes (e.g. pinene and limonene), indenes

(a54-3) Aromatic Vinyl Hydrocarbon

Aromatic unsaturated compounds having 8 to 20 carbon atoms or more, such as styrene, α-methylstyrene, vinyltoluene, 2,4-dimethylstyrene, ethylstyrene, isopropylstyrene, butylstyrene, phenylstyrene, cyclohexylstyrene, benzylstyrene

(a55) Vinyl Ester

Aliphatic vinyl esters [4 to 15 carbon atoms, such as alkenyl esters of aliphatic carboxylic acids (mono- or dicarboxylic acids) (such as vinyl acetate, vinyl propionate, vinyl butyrate, diallyl adipate, isopropenyl acetate, vinyl methoxy acetate)]

Aromatic vinyl esters [9 to 20 carbon atoms, such as alkenyl esters of aromatic carboxylic acids (mono- or dicarboxylic acids) (such as vinyl benzoate, diallyl phthalate, methyl-4-vinyl benzoate), aromatic ring-containing aliphatic carboxylic acids ester (e.g. acetoxystyrene)]

(a56) Vinyl Ether

Aliphatic vinyl ethers [3 to 15 carbon atoms, such as vinyl alkyl (1 to 10 carbon atoms) ethers (vinyl methyl ether, vinyl butyl ether, vinyl 2-ethylhexyl ether, etc.), vinyl alkoxy (1 to 6 carbon atoms) alkyl (carbon atoms 1-4) Ethers (vinyl-2-methoxyethyl ether, methoxybutadiene, 3,4-dihydro-1,2-pyran, 2-butoxy-2′-vinyloxydiethyl ether, vinyl-2-ethylmercaptoethyl ether, etc.)), poly (2-4) (meth)allyloxyalkane (carbon number 2-6) (diallyloxyethane, triallyloxyethane, tetraallyloxybutane, tetramethallyloxyethane, etc.)], aromatic vinyl ether (8 to 20 carbon atoms, e.g. vinyl phenyl ether, phenoxystyrene)

(a57) Vinyl Ketone

Aliphatic vinyl ketones (4 to 25 carbon atoms, e.g. vinyl methyl ketone, vinyl ethyl ketone), aromatic vinyl ketones (9 to 21 carbon atoms, e.g. vinyl phenyl ketone)

(a58) Unsaturated Dicarboxylic Acid Diester Unsaturated

Dicarboxylic acid diester having 4 to 34 carbon atoms, for example, dialkyl fumarate (two alkyl groups are linear, branched or alicyclic groups having 1 to 22 carbon atoms), dialkyl maleate (two alkyl groups are linear, branched or alicyclic groups having 1 to 22 carbon atoms)

When the radically polymerizable monomer (a5) is contained, the content thereof based on the weight of all monomers is preferably 0.1 to 3.0 wt %.

A preferable lower limit of the weight average molecular weight of polymer compound constituting the coating layer is 3,000, a more preferable lower limit is 5,000, and a still more preferable lower limit is 7,000. On the other hand, a preferable upper limit of the weight average molecular weight of coating resin is 100,000, and a more preferable upper limit is 70,000.

The weight average molecular weight of the polymer compound constituting the coating layer can be obtained by gel permeation chromatography (hereinafter abbreviated as GPC) measurement under the following conditions.
Device: Alliance GPC V2000 (commercially available from Waters)
Solvent: ortho-dichlorobenzene, DMF, THE
Standard substance: polystyrene
Sample concentration: 3 mg/ml
Column stationary phase: PLgel 10 μm, MIXED-B 2 columns in series (commercially available from Polymer Laboratories Ltd.)
Column temperature: 135° C.

The polymer compound constituting the coating layer can be produced using a known polymerization initiator {azo initiator [2,2′-azobis (2-methylpropionitrile), 2,2′-azobis (2,4-dimethylvaleronitrile), 2,2′-azobis (2-methylbutyronitrile), etc.], peroxide initiator (benzoyl peroxide, di-t-butyl peroxide, lauryl peroxide, etc.) or the like} by a known polymerization method (bulk polymerization, solution polymerization, emulsion polymerization, suspension polymerization, etc.).

In order to adjust the weight-average molecular weight to be within a preferable range, the amount of the polymerization initiator used based on the total weight of the monomers is preferably 0.01 to 5 wt %, more preferably 0.05 to 2 wt %, and still more preferably 0.1 to 1.5 wt %, and the polymerization temperature and the polymerization time are adjusted depending on the type of the polymerization initiator and the like, and polymerization is performed at a polymerization temperature of preferably −5 to 150° C., (more preferably 30 to 120° C.) for a reaction time of preferably 0.1 to 50 hours (more preferably 2 to 24 hours).

Examples of solvents used in the solution polymerization include esters (with 2 to 8 carbon atoms, for example, ethyl acetate and butyl acetate), alcohols (with 1 to 8 carbon atoms, for example, methanol, ethanol and octanol), hydrocarbons (with 4 to 8 carbon atoms, for example, n-butane, cyclohexane and toluene), amides (for example, N,N-dimethylformamide (hereafter abbreviated as DMF)) and ketones (with 3 to 9 carbon atoms, for example, methyl ethyl ketone), and in order to adjust the weight-average molecular weight to be within a preferable range, the amount thereof used based on the total weight of the monomers is preferably 5 to 900 wt %, more preferably 10 to 400 wt %, and still more preferably 30 to 300 wt %, and the monomer concentration is preferably 10 to 95 wt %, more preferably 20 to 90 wt %, and still more preferably 30 to 80 wt %.

Examples of dispersion media for emulsion polymerization and suspension polymerization include water, alcohols (for example, ethanol), esters (for example, ethyl propionate), and light naphtha, and examples of emulsifiers include (C10-C24) higher fatty acid metal salts (for example, sodium oleate and sodium stearate), (C10-C24) higher alcohol sulfate metal salts (for example, sodium lauryl sulfate), ethoxylated tetramethyldecynediol, sodium sulfoethyl methacrylate, and dimethylaminomethyl methacrylate. In addition, polyvinyl alcohol, polyvinylpyrrolidone or the like may be added as the stabilizer.

The monomer concentration of the solution or dispersion liquid is preferably 5 to 95 wt %, more preferably 10 to 90 wt %, and still more preferably 15 to 85 wt %, and the amount of the polymerization initiator used based on the total weight of the monomers is preferably 0.01 to 5 wt %, and more preferably 0.05 to 2 wt %.

During polymerization, a known chain transfer agent, for example, a mercapto compound (dodecyl mercaptan, n-butyl mercaptan, etc.) and/or a halogenated hydrocarbon (carbon tetrachloride, carbon tetrabromide, benzyl chloride, etc.), can be used.

The polymer compound constituting the coating layer may be a crosslinked polymer obtained by cross-linking said polymer with a cross-linking agent (A′) having a reactive functional group that reacts with a carboxyl group {preferably a polyepoxy compound (a′1) [polyglycidyl ether (bisphenol A diglycidyl ether, propylene glycol diglycidyl ether, glycerin triglycidyl ether, etc.), polyglycidylamine (N,N-diglycidylaniline and 1,3-bis (N,N-diglycidylaminomethyl)) and the like] and/or a polyol compound (a′2) (ethylene glycol, etc.)}.

Examples of methods of cross-linking a polymer compound constituting the coating layer using a cross-linking agent (A′) include a method of coating cathode active material particles with a polymer compound constituting the coating layer and then performing cross-linking. Specifically, a method in which cathode active material particles and a resin solution containing a polymer compound constituting the coating layer are mixed, the solvent is removed to produce coated active material particles, and a solution containing the cross-linking agent (A′) is then mixed with the coated active material particles and heated, and thus the solvent is removed, a cross-linking reaction is caused, and a reaction in which the polymer compound constituting the coating layer is cross-linked with the cross-linking agent (A′) is caused on the surface of cathode active material particles may be exemplified.

The heating temperature is adjusted depending on the type of the cross-linking agent, and when the polyepoxy compound (a′1) is used as the cross-linking agent, the heating temperature is preferably 70° C. or higher, and when the polyol compound (a′2) is used, the heating temperature is preferably 120° C. or higher.

The conductive assistant is preferably selected from among materials having conductivity.

Examples of preferable conductive assistants include metals [aluminum, stainless steel (SUS), silver, gold, copper, titanium, etc.], carbon [graphite, carbon black (acetylene black, ketjen black, furnace black, channel black, thermal lamp black, etc.) and the like], and mixtures thereof.

These conductive assistants may be used alone or two or more thereof may be used in combination. In addition, alloys or metal oxides thereof may be used.

Among these, in consideration of electrical stability, aluminum, stainless steel, carbon, silver, gold, copper, titanium and mixtures thereof are more preferable, silver, gold, aluminum, stainless steel and carbon are still more preferable, and carbon is particularly preferable.

In addition, these conductive assistants may be those obtained by coating a conductive material [preferably, a metal assistant among the above conductive assistants] around a particulate ceramic material or a resin material by plating or the like.

The shape (form) of the conductive assistant is not limited to a particle form, and may be a form other than the particle form, and may be a form that is put into practical use as a so-called fiber-based conductive assistant such as carbon nanofibers and carbon nanotubes.

The average particle size of the conductive assistant is not particularly limited, and in consideration of electrical characteristics of the battery, it is preferably about 0.01 to 10 μm.

In this specification, the “particle size of the conductive assistant” is the maximum distance L among the distances between arbitrary two points on the outline of the conductive assistant. As the value of “average particle size”, the value calculated as an average value of the particle sizes of the particles observed in several to several tens of fields of view using an observation device such as a scanning electron microscope (SEM) or a transmission electron microscope (TEM) is used.

The ratio between the polymer compound constituting the coating layer and the conductive assistant is not particularly limited, and in consideration of the internal resistance of the battery and the like, the weight ratio between the polymer compound constituting the coating layer (resin solid content weight):the conductive assistant is preferably 1:0.01 to 1:50 and more preferably 1:0.2 to 1:3.0.

The BET specific surface area of the ceramic particles is 70 to 300 m²/g.

If the BET specific surface area of the ceramic particles is less than 70 m²/g, side reactions between the electrolytic solution and the coated cathode active material particles cannot be sufficiently suppressed. As a result, it is not possible to prevent the internal resistance value of the lithium-ion battery from increasing.

On the other hand, it is technically difficult to prepare ceramic particles with a BET specific surface area having more than 300 m²/g.

The BET specific surface area of the ceramic particles is preferably 110 m²/g or more, more preferably 125 m²/g or more, even more preferably 140 m²/g or more, and particularly preferably 150 m²/g or more.

The BET specific surface area of the ceramic particles can be measured based on “JIS Z 8830:2013 Method for measuring specific surface area of powder (solid) by gas adsorption” while using, for example, the following apparatus and measurement conditions.

Measuring device: Mountec Co., Ltd. Macsorb (registered trademark) HMmodel-1201 Adsorbed gas: N₂
Dead volume measurement gas: Mixed gas (N₂ 30%+He 70%)
Adsorption temperature: 77K
Pre-measurement treatment: Drying at 100° C. for 5 minutes under nitrogen atmosphere

Examples of ceramic particles include metal carbide particles, metal oxide particles, and glass ceramic particles.

Examples of metal carbide particles include silicon carbide (SiC), tungsten carbide (WC), molybdenum carbide (MO₂C), titanium carbide (TiC), tantalum carbide (TaC), niobium carbide (NbC), vanadium carbide (VC), and zirconium carbide (ZrC).

Examples of metal oxide particles include particles of zinc oxide (ZnO), aluminum oxide (Al₂O₃), silicon dioxide (SiO₂), tin oxide (SnO₂), titania (TiO₂), zirconia (ZrO₂), indium oxide (In₂O₃), Li₂B₄O₇, Li₄Ti₅O₁₂, Li₂Ti₂O₅, LiTaO₃, LiNbO₃, LiAlO₂, Li₂ZrO₃, Li₂WO₄, Li₂TiO₃, Li₃PO₄, Li₂MoO₄, Li₃BO₃, LiBO₂, Li₂CO₃, Li₂SiO₃ and a perovskite oxide represented by ABO₃ (where, A is at least one selected from the group consisting of Ca, Sr, Ba, La, Pr and Y, and B is at least one selected from the group consisting of Ni, Ti, V, Cr, Mn, Fe, Co, Mo, Ru, Rh, Pd and Re).

As the metal oxide particles, in order to suitably inhibit a side reaction that occurs between the electrolytic solution and the coated cathode active material particles, aluminum oxide (Al₂O₃), silicon dioxide (SiO₂) and lTitania (TiO₂) are preferable. Silicon dioxide (SiO₂) is more preferable.

As the ceramic particles, in order to suitably inhibit a side reaction that occurs between the electrolytic solution and the coated cathode active material particles, glass ceramic particles are preferable. These may be used alone or two or more thereof may be used in combination.

The glass ceramic particles are preferably a lithium-containing phosphate compound having a rhombohedral crystal system and a chemical formula thereof is represented by LiₓM″₂P₃O₁₂ (X=1 to 1.7). Here, M″ is one or more elements selected from the group consisting of Zr, Ti, Fe, Mn, Co, Cr, Ca, Mg, Sr, Y, Sc, Sn, La, Ge, Nb, and Al. In addition, some P may be replaced with Si or B, and some 0 may be replaced with F, Cl or the like. For example, Li_{1.15}Ti_{1.85}Al_{2.15}Si_{0.05}P_{2.95}O₁₂, Li_{1.2}Ti_{1.8}Al_{2.1}Ge_{0.1}Si_{0.05}P₂₉₅O₁₂ or the like can be used.

In addition, materials with different compositions may be mixed or combined, and the surface may be coated with a glass electrolyte or the like. Alternatively, it is preferable to use glass ceramic particles that precipitate a crystal phase of a lithium-containing phosphate compound having a NASICON type structure according to a heat treatment.

Examples of glass electrolytes include the glass electrolyte described in Japanese Patent Application Publication No. 2019-96478.

Here, the mixing proportion of Li₂O in the glass ceramic particles is preferably 8 mass % or less in terms of oxide.

In addition to a NASICON type structure, a solid electrolyte which is composed of Li, La, Mg, Ca, Fe, Co, Cr, Mn, Ti, Zr, Sn, Y, Sc, P, Si, O, In, Nb, or F, has a LISICON type, perovskite type, β-Fe₂ (SO₄)₃ type, or Li₃In₂ (PO₄)₃ type crystal structure, and transmits 1×10⁻⁵ S/cm or more of Li ions at room temperature may be used.

The above ceramic particles may be used alone or two or more thereof may be used in combination.

In consideration of the energy density and electrical resistance value, the volume average particle size of the ceramic particles is preferably 1 to 1,000 nm, more preferably 1 to 500 nm, and still more preferably 1 to 150 nm.

In this specification, the volume average particle size means the particle size (Dv50) at an integrated value of 50% in the particle size distribution obtained by the microtrack method (the laser diffraction/scattering method). The microtrack method is a method of determining a particle size distribution by using scattered light obtained by irradiating particles with laser light. A MICROTRAC manufactured by Nikkiso Co, Ltd. can be used for measuring the volume average particle size.

The weight proportion of the ceramic particles is preferably 1.0 to 5.0 wt % based on the weight of the coated cathode active material particles for lithium-ion batteries.

With the ceramic particles contained in the above range, side reactions between the electrolytic solution and the coated cathode active material particles can be suitably suppressed. In addition, since the coating layer of the coated cathode active material particles has excellent flexibility, in a case when forming a cathode active material layer by pressing the coated cathode active material particles according to the way mentioned below, it is possible to obtain a cathode active material layer with high energy density.

The weight proportion of the ceramic particles is more preferably 2.0 to 4.0 wt % based on the weight of the coated cathode active material particles for lithium-ion batteries.

At least a part of the surface of the cathode active material particles is coated with a coating layer.

In consideration of cycle characteristics, the coverage (obtained by the following calculation formula) of the cathode active material particles is preferably 30 to 95%.

$$Coverage ( \% ) = \{ 1 - [ BET specific surface area of coated cathode active material particles / ( BET specific surface area of cathode active material particles \times weight proportion of cathode active material particles contained in coated cathode active material particles + BET specific surface area of \\ conductive assistant \times weight proportion of conductive assistant contained in coated cathode active material particles + BET specific surface area of ceramic particles \times weight proportion of ceramic particles contained in coated cathode active material particles ) ] \} \times 100$$

### [Method of Producing Coated Cathode Active Material Particles for Lithium-Ion Batteries]

The method of producing coated cathode active material particles for lithium-ion batteries according to this invention (Hereinafter, also simply referred to as “method of producing coated cathode active material particles”) includes a step of removing a solvent after mixing cathode active material particles, a polymer compound, a conductive assistant, ceramic particles, and an organic solvent.

The organic solvent is not particularly limited as long as it can dissolve the polymer compound, and any known organic solvent can be appropriately selected and used.

In the method of producing coated cathode active material particles, first, cathode active material particles, a polymer compound constituting the coating layer, a conductive assistant, and ceramic particles are mixed in the organic solvent. In a case when the cathode active material particles, the polymer compound constituting the coating layer, the conductive assistant, and the ceramic particles are mixed, the order is not particularly limited. For example, a resin composition consisting of a polymer compound constituting the coating layer, a conductive assistant, and ceramic particles may be further mixed with the cathode active material particles, wherein the resin compound was pre-mixed. The cathode active material particles, the polymer compound constituting the coating layer, the conductive assistant, and the ceramic particles may be mixed at the same time. A polymer compound constituting the coating layer may be mixed with the cathode active material particles. Further, a conductive assistant and ceramic particles may be mixed therein.

The coated cathode material particles for lithium-ion batteries of this invention can be obtained by covering cathode material particles with a coating layer containing a polymer compound, a conductive assistant and ceramic particles, for example, while the cathode material particles are put into a universal mixer and stirred at 30 to 500 rpm, the particles can be obtained. When resin solution containing a polymer compound that forms the coating layer is added dropwise over 1 to 90 minutes and mixed, the conductive assistant and the ceramic particles are mixed, the temperature is raised to 50 to 200° C. with stirring, the pressure is reduced to 0.007 to 0.04 MPa, the sample is then left for 10 to 150 minutes, and the solvent is removed.

The mixing ratio of the cathode active material particles, and the resin composition consisting of a polymer compound constituting the coating layer, a conductive assistant, and ceramic particles is not particularly limited, and the weight ratio of the cathode active material particles: the resin composition is preferably 1:0.001 to 0.1.

### [Cathode for Lithium-Ion Batteries]

The cathode for lithium-ion batteries (hereinafter also simply referred to as “cathode”) of the present invention comprises the coated cathode active material particles of the present invention and a cathode active material layer with an electrolytic solution containing an electrolyte and a solvent.

The amount of the coated cathode active material particles contained in the cathode active material layer is preferably 40 to 95 wt % based on the weight of the cathode active material layer and is more preferably 60 to 90 wt %.

As the electrolyte, electrolytes used in known electrolytic solutions can be used, and for example, lithium salts of inorganic anions such as LiPF₆, LiBF₄, LiSbF₆, LiAsF₆, LiClO₄ and LiN(FSO₂)₂, and lithium salts of organic anions such as LiN(CF₃SO₂)₂, LiN(C₂F₅SO₂)₂ and LiC(CF₃SO₂)₃ may be exemplified. Among these, LiN(FSO₂)₂ is preferable in consideration of the battery output and charging and discharging cycle characteristics.

As the solvent, non-aqueous solvents used in known electrolytic solutions can be used, and for example, lactone compounds, cyclic or chain carbonates, chain carboxylates, cyclic or chain ethers, phosphate esters, nitrile compounds, amide compounds, sulfone, sulfolane and mixtures thereof can be used.

Examples of lactone compounds include 5-membered ring (y-butyrolactone, y-valerolactone, etc.) and 6-membered ring (5-valerolactone, etc.) lactone compounds.

Examples of cyclic carbonates include propylene carbonate, ethylene carbonate (EC) and butylene carbonate (BC).

Examples of chain carbonates include dimethyl carbonate (DMC), methyl ethyl carbonate (MEC), diethyl carbonate (DEC), methyl-n-propyl carbonate, ethyl-n-propyl carbonate and di-n-propyl carbonate.

Examples of chain carboxylates include methyl acetate, ethyl acetate, propyl acetate and methyl propionate.

Examples of cyclic ethers include tetrahydrofuran, tetrahydropyran, 1,3-dioxolane and 1,4-dioxane. Examples of chain ethers include dimethoxymethane and 1,2-dimethoxyethane.

Examples of phosphate esters include trimethyl phosphate, triethyl phosphate, ethyldimethyl phosphate, diethylmethyl phosphate, tripropyl phosphate, tributyl phosphate, tri(trifluoromethyl) phosphate, tri(trichloromethyl) phosphate, tri(trifluoroethyl) phosphate, tri(triperfluoroethyl) phosphate, 2-ethoxy-1,3,2-dioxaphospholan-2-one, 2-trifluoroethoxy-1,3,2-dioxaphospholan-2-one and 2-methoxyethoxy-1,3,2-dioxaphospholan-2-one.

Examples of nitrile compounds include acetonitrile. Examples of amide compounds include DMF. Examples of sulfones include dimethyl sulfone and diethyl sulfone.

These solvents may be used alone or two or more thereof may be used in combination.

The concentration of the electrolyte in the electrolytic solution is preferably 1.2 to 5.0 mol/L, more preferably 1.5 to 4.5 mol/L, still more preferably 1.8 to 4.0 mol/L, and particularly preferably 2.0 to 3.5 mol/L.

Since such an electrolytic solution has an appropriate viscosity, it can form a liquid film between the coated cathode active material particles, and impart a lubrication effect (an ability to adjust the position of coated active material particles) to the coated cathode active material particles.

The cathode active material layer may further contain a conductive assistant in addition to the conductive assistant that is contained as necessary in the coating layer of the above coated cathode active material particles. While the conductive assistant that is contained as necessary in the coating layer is integrated with the coated cathode active material particles, the conductive assistant contained in the cathode active material layer can be distinguished in that it is contained separately from the coated cathode active material particles.

As the conductive assistant that the cathode active material layer may contain, those described in <Coated cathode active material particles for lithium-ion batteries> can be used.

When the cathode active material layer contains a conductive assistant, the total content of the conductive assistant contained in the cathode and the conductive assistant contained in the coating layer based on the weight of the cathode active material layer excluding the electrolytic solution is preferably less than 4 wt % and more preferably less than 3 wt %. On the other hand, the total content of the conductive assistant contained in the cathode and the conductive assistant contained in the coating layer based on the weight of the cathode active material layer excluding the electrolytic solution is preferably 2.5 wt % or more.

The cathode active material layer preferably does not contain a binder.

Here, in this specification, the binder refers to an agent that cannot reversibly fix the cathode active material particles to each other and the cathode active material particles to the current collector, and known solvent-drying type binders for lithium ion batteries such as starch, polyvinylidene fluoride, polyvinyl alcohol, carboxymethyl cellulose, polyvinylpyrrolidone, tetrafluoroethylene, styrene butadiene rubber, polyethylene and polypropylene may be exemplified.

These binders are used by being dissolved or dispersed in a solvent, and are solidified by volatilizing and distilling off the solvent to irreversibly fix the cathode active material particles to each other and the cathode active material particles to the current collector.

The cathode active material layer may contain an adhesive resin. The adhesive resin is a resin that does not solidify and has adhesiveness even if the solvent component is volatilized and dried, and is a material different and distinguished from the binder.

In addition, while the coating layer constituting the coated cathode active material particles is fixed to the surface of cathode active material particles, the adhesive resin reversibly fixes the surfaces of the cathode active material particles to each other. The adhesive resin can be easily separated from the surface of cathode active material particles, but the coating layer cannot be easily separated. Therefore, the coating layer and the adhesive resin are different materials.

As the adhesive resin, polymers which contain at least one low Tg monomer selected from the group consisting of vinyl acetate, 2-ethylhexyl acrylate, 2-ethylhexyl methacrylate, butyl acrylate and butyl methacrylate as an essential constituent monomer, and in which the total weight proportion of the low Tg monomers based on the total weight of the constituent monomers is 45 wt % or more may be exemplified.

When the adhesive resin is used, it is preferable to use 0.01 to 10 wt % of the adhesive resin based on the total weight of the cathode active material particles.

As for the cathode for lithium-ion batteries of this invention, the weight proportion of the polymer compound contained in the cathode for lithium-ion batteries based on the weight of the cathode for lithium-ion batteries is 1 to 10 wt %.

Here, the “polymer compound” refers to a polymer compound constituting a coating layer, a binder and an adhesive resin, and in the cathode for lithium-ion batteries, the total weight proportion of the polymer compound constituting the coating layer and the adhesive resin is equal to the above “weight proportion of the polymer compound” and contains no binder (0 wt %).

In terms of the cathode for lithium-ion batteries of this invention, the cathode active material layer is formed of a non-bound component of the coated cathode active material particles for lithium-ion batteries.

Herein, it is called a non-bound component because the position of the cathode active material particles is not fixed in the cathode active material layer, and the cathode active material particles and the cathode active material particles and the current collector are not irreversibly fixed.

When the cathode active material layer is a non-bound component, this is preferable because, since the cathode active material particles are not irreversibly fixed to each other, it is possible to separate the cathode active material particles from each other without causing breakage at the interface, and even if stress is applied to the cathode active material layer, the movement of the cathode active material particles can prevent the cathode active material layer from being broken. The cathode active material layer which is a non-bound component can be obtained by a method such as using a cathode active material layer slurry containing cathode active material particles, an electrolytic solution or the like and not containing a binder as the cathode active material layer.

In consideration of battery performance, the thickness of the cathode active material layer is preferably 150 to 600 μm and more preferably 200 to 470 μm.

As for the cathode for lithium-ion batteries of this invention, for example, a powder (cathode precursor) obtained by mixing the coated cathode active material particles for lithium-ion batteries of this invention and, if necessary, a conductive assistant, etc., can also be produced by pouring the powder int an electrolytic solution after applying the powder to the current collector and pressing it with a press machine to form an cathode active material layer.

In addition, it is fine that the cathode precursor is applied onto a release film and pressed to form an cathode active material layer, and after the cathode active material layer is transferred to a current collector, the electrolytic solution may be injected.

Further, the cathode for lithium-ion batteries of the present invention can be produced, for example, by applying an cathode active material layer slurry containing the above coated cathode active material particles, an electrolytic solution containing an electrolyte and a solvent, as necessary, a conductive assistant and the like to a current collector and then drying it. Specifically, a method in which an cathode active material layer slurry is applied onto a current collector using a coating device such as a bar coater, the non-woven fabric is then left on the cathode active material particles to absorb a liquid, and thus the solvent is removed, and as necessary, pressing is performed with a press machine may be exemplified.

Examples of materials constituting the current collector include metal materials such as copper, aluminum, titanium, stainless steel, nickel and alloys thereof, and calcined carbon, conductive polymer materials, and conductive glass.

The shape of the current collector is not particularly limited, and a sheet-like current collector made of the above material and a deposition layer including fine particles composed of the above material may be used.

The thickness of the current collector is not particularly limited, but is preferably 50 to 500 μm.

The cathode for lithium-ion batteries further comprises a current collector, and the cathode active material layer is preferably provided on the surface of the current collector. For example, the cathode of the present invention preferably comprises a resin current collector made of a conductive polymer material, and the cathode active material layer is provided on the surface of the resin current collector.

As the conductive polymer material constituting the resin current collector, for example, those obtained by adding a conducting agent to a resin can be used.

As the conducting agent constituting the conductive polymer material, the same conductive assistant which is an optional component for the coating layer can be preferably used.

Examples of resins constituting the conductive polymer material include polyethylene (PE), polypropylene (PP), polymethylpentene (PMP), polycycloolefin (PCO), polyethylene terephthalate (PET), polyethernitrile (PEN), polytetrafluoroethylene (PTFE), styrene butadiene rubber (SBR), polyacrylonitrile (PAN), polymethyl acrylate (PMA), polymethyl methacrylate (PMMA), polyvinylidene fluoride (PVdF), epoxy resins, silicone resins and mixtures thereof.

In consideration of electrical stability, polyethylene (PE), polypropylene (PP), polymethylpentene (PMP) and polycycloolefin (PCO) are preferable, and polyethylene (PE), polypropylene (PP) and polymethylpentene (PMP) are more preferable.

The resin current collector can be obtained by known methods described in Japanese Patent Application Publication No. 2012-150905, WO 2015/005116 and the like.

### [Lithium Ion Battery]

A lithium ion battery can be obtained by combining the above cathode with an electrode that serves as a counter electrode, housing it in a cell container together with a separator, injecting an electrolytic solution, and sealing the cell container.

In addition, a lithium ion battery can be obtained by forming the cathode of this invention on one side of a current collector, forming an anode on the other side to produce a bipolar type electrode, laminating the bipolar type electrode and a separator, housing it in a cell container, injecting an electrolytic solution, and sealing the cell container.

Examples of separators include known separators for lithium-ion batteries such as polyethylene or polypropylene porous films, laminated films of a porous polyethylene film and a porous polypropylene, non-woven fabrics composed of synthetic fibers (polyester fibers, aramid fibers, etc.), glass fibers or the like, and those with ceramic fine particles such as silica, alumina, and titania adhered to their surfaces.

### EXAMPLES

Next, the present invention will be described in detail with reference to examples, but the present invention is not limited to the examples as long as it does not depart from the spirit of the present invention. Here, unless otherwise specified, parts means parts by weight, and % means wt %.

### <Production of Coating Polymer Compound>

150 parts of DMF was put into a 4-neck flask including a stirrer, a thermometer, a reflux cooling tube, a dropping funnel and a nitrogen gas inlet tube, and the temperature was raised to 75° C. Next, a monomer composition in which 91 parts of acrylic acid, 9 parts of methyl methacrylate and 50 parts of DMF were mixed and an initiator solution in which 0.3 parts of 2,2′-azobis(2,4-dimethylvaleronitrile) and 0.8 parts of 2,2′-azobis(2-methylbutyronitrile) were dissolved in 30 parts of DMF were continuously added dropwise over 2 hours through a dropping funnel with stirring while blowing nitrogen into the 4-neck flask to cause radical polymerization. After dropwise addition was completed, the reaction was continued at 75° C. for 3 hours. Next, the temperature was raised to 80° C., the reaction was continued for 3 hours, and a copolymer solution having a resin concentration of 30% was obtained. The obtained copolymer solution was transferred to a Teflon (registered trademark) bat and dried under a reduced pressure at 150° C. and 0.01 MPa for 3 hours, and DMF was distilled off to obtain a copolymer. This copolymer was coarsely pulverized with a hammer and then additionally pulverized with a mortar to obtain a powdered coating polymer compound.

### <Production of Electrolytic Solution>

An electrolytic solution was prepared by dissolving LiN(FSO₂)₂ at a proportion of 2.0 mol/L in a solvent mixture containing ethylene carbonate (EC) and propylene carbonate (PC) (volume ratio of 1:1).

### <Ceramic Particles>

The following materials were prepared as ceramic particles. SiO₂ (silicon dioxide particles, BET specific surface area 72.5 m²/g, item SiO₂, manufactured by Kanto Kagaku Co., Ltd.)

AEROSIL R972 (silicon dioxide, BET specific surface area 110 m²/g, product name “AEROSIL R972”, manufactured by Nippon Aerosil Co., Ltd.)

REOLOSIL DM-10 (silicon dioxide, BET specific surface area 115 m²/g, product name “REOLOSIL DM-10”, manufactured by Tokuyama Corporation)

REOLOSIL MT-10 (silicon dioxide, BET specific surface area 126 m²/g, product name “REOLOSIL MT-10”, manufactured by Tokuyama Corporation)

NIPSIL NA (silicon dioxide, BET specific surface area 140 m²/g, product name “NIPSIL NA”, manufactured by Tosoh Corporation)

NIPSIL NS-T (Silicon dioxide, BET specific surface area 160 m²/g, product name “NIPSIL NS-T”, manufactured by Tosoh Corporation)

AEROSIL R974 (silicon dioxide, BET specific surface area 170 m2/g, product name “AEROSIL R974”, manufactured by Nippon Aerosil Co., Ltd.)

ULTRASIL VN3 (silicon dioxide, BET specific surface area 170 m²/g, product name “ULTRASIL VN3”, manufactured by Evonik)

AEROSIL 200 (silicon dioxide, BET specific surface area 200 m²/g, product name “AEROSIL 200”, manufactured by Nippon Aerosil Co., Ltd.)

AEROSIL 300 (silicon dioxide, BET specific surface area 300 m²/g, product name “AEROSIL 300”, manufactured by Nippon Aerosil Co., Ltd.)

Al₂O₃ (aluminum oxide, BET specific surface area 71.2 m²/g, item Al₂O₃, manufactured by Kanto Kagaku Co., Ltd.)

TiO₂ (titania, BET specific surface area 73.6 m²/g, item TiO₂, manufactured by Kanto Kagaku Co., Ltd.)

AEROSIL 50 (silicon dioxide, BET specific surface area 50 m²/g, product name “AEROSIL 50”, manufactured by Nippon Aerosil Co., Ltd.) The BET specific surface area of the ceramic particles were measured based on “JIS Z 8830:2013 Method for measuring specific surface area of powder (solid) by gas adsorption” while using, for example, the following apparatus and measurement conditions.

Measuring device: Mountec Co., Ltd. Macsorb (registered trademark) HMmodel-1201
Adsorbed gas: N₂
Dead volume measurem20ent gas: Mixed gas (N₂ 30%+He 70%)
Adsorption temperature: 77K
Pre-measurement treatment: Drying at 100° C. for 5 minutes under nitrogen atmosphere

### Example 1

### [Production of Coated Cathode Active Material Particles]

1 part of the coating polymer compound was dissolved in 3 parts of DMF to obtain a coating polymer compound solution.

When 90.12 parts of cathode active material particles (LiNi0.8Co_{0.15}Al_{0.05}O₂ powder, volume average particle diameter 4 μm) were put into a Universal Mixer High Speed Mixer FS25 [commercially available from EARTHTECHNICA Co., Ltd.] and stirred at room temperature and 720 rpm, 12.56 parts of the coating polymer compound solution was added dropwise over 2 minutes and additionally stirred for 5 minutes.

Next, in a stirred state, 3.14 parts of acetylene black (Denka Black (registered trademark) manufactured by Denka Co., Ltd.) as a conductive assistant and 2.10 parts of ceramic particles (SiO₂) were added in portions for 2 minutes, and the stirring was continued for 30 minutes.

Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles.

### [Production of Resin Current Collector]

70 parts of polypropylene [product name “SunAllomer PL500A”, commercially available from SunAllomer Ltd.], 25 parts of carbon nanotubes [product name: “FloTube9000”, commercially available from CNano] and 5 parts of a dispersing agent [product name “UMEX 1001”, commercially available from Sanyo Chemical Industries, Ltd.] were melt-kneaded using a twin-screw extruder under conditions of 200° C. and 200 rpm to obtain a resin mixture.

The obtained resin mixture was passed through a T-die extrusion film forming machine and stretched and rolled to obtain a conductive film for a resin current collector having a film thickness of 100 μm. Next, the obtained conductive film for a resin current collector was cut into circular shapes with a diameter of 15 mm or 16 mm, one side was subjected to nickel vapor deposition and a resin current collector to which a current extraction terminal (5 mm×3 cm) was connected was then obtained.

Herein, a circular resin current collector with a diameter of 15 mm was used as the resin current collector for cathode, and a circular resin current collector with a diameter of 16 mm was used as the resin current collector for anode.

### [Production of Cathode for Lithium-Ion Batteries]

A cathode precursor was prepared by mixing 98.50 parts of the prepared coated cathode active material particles, 2.06 parts of carbon fiber [DONACARBO Milled S-243, commercially available from Osaka Gas Chemicals Co., Ltd.: an average fiber length of 500 μm, an average fiber diameter of 13 μm: an electrical conductivity of 200 mS/cm], and 1.03 parts of Ketjenblack [EC300J manufactured by Lion Specialty Chemicals Co., Ltd.].

The prepared cathode precursor was filled onto a Φ15 mold so that the basis weight of the cathode active material was 50 mg/cm². Then the cathode active material layer (thickness: 213 μm) was formed by compression molding using a press machine (HANDTAB-100T15, manufactured by Ichihashi Seiki Co., Ltd.) at a pressure of 1 ton/cm². And then a cathode for lithium-ion batteries (circular with a diameter of 15 mm) according to Example 1 was produced by laminating it on one side of the resin current collector.

### [Production of Coated Anode Active Material Particles A]

1 part of the coating polymer compound was dissolved in 3 parts of DMF to obtain a coating polymer compound solution.

When 80.04 parts of the anode active material particles (hard carbon powder, a volume average particle size of 25 μm) were put into a Universal Mixer High Speed Mixer FS25 [commercially available from EARTHTECHNICA Co., Ltd.] and stirred at room temperature and 720 rpm, 37.92 parts of the coating polymer compound solution was added dropwise over 2 minutes and additionally stirred for 5 minutes.

Next, under stirring, 9.48 parts of acetylene black [Denka Black (registered trademark), commercially available from Denka Co., Ltd.] as a conductive assistant were added over 2 minutes in a divided manner, and stirring was continued for 30 minutes.

Then, the pressure was reduced to 0.01 MPa while stirring was maintained, the temperature was then raised to 140° C. while stirring and the degree of pressure reduction were maintained, and volatile components were distilled off while stirring, the degree of pressure reduction and the temperature were maintained for 8 hours. The obtained powder was classified with a sieve with an opening of 200 μm to obtain coated anode active material particles.

### [Production of Anode for Lithium-Ion Batteries]

An anode precursor was prepared by mixing 99 parts of the produced coated anode active material particles with 1 part of carbon fiber [DONACARBO Milled S-243, commercially available from Osaka Gas Chemicals Co., Ltd.: an average fiber length of 500 μm, an average fiber diameter of 13 μm: an electrical conductivity of 200 mS/cm].

The prepared anode precursor was filled onto a Φ16 mold so that the basis weight of the cathode active material was 23.4 mg/cm². Then the anode active material layer (thickness: 300 μm) was formed by compression molding using a press machine (HANDTAB-100T15, manufactured by Ichihashi Seiki Co., Ltd.) at a pressure of 1 ton/cm². And then an anode for lithium-ion batteries (circular with a diameter of 16 mm) was produced by laminating it on one side of the resin current collector.

### [Production of Lithium-Ion Batteries]

The obtained cathode for lithium-ion batteries was combined with the anode for lithium-ion batteries via a separator (#3501, commercially available from Celgard LLC) to produce lithium-ion batteries.

### Examples 2 to 10

Coated cathode active material particles were produced in the same manner as in Example 1, except that the ceramic particles were changed as shown in Table 1, then a cathode for lithium-ion batteries and a lithium-ion battery were produced.

### Example 11

### [Production of Coated Cathode Active Material Particles]

1 part of the coating polymer compound was dissolved in 3 parts of DMF to obtain a coating polymer compound solution.

When 90.21 parts of cathode active material particles (LiNi0.8Co_{0.15}Al_{0.05}O₂ powder, volume average particle diameter 4 μm) were put into a Universal Mixer High Speed Mixer FS25 [commercially available from EARTHTECHNICA Co., Ltd.] and stirred at room temperature and 720 rpm, 12.60 parts of the coating polymer compound solution was added dropwise over 2 minutes and additionally stirred for 5 minutes.

Next, in a stirred state, 3.15 parts of acetylene black (Denka Black (registered trademark) manufactured by Denka Co., Ltd.) as a conductive assistant and 2.00 parts of ceramic particles (SiO₂) were added in portions for 2 minutes, and the stirring was continued for 30 minutes.

Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles. Coated cathode active material particles were produced in the same manner as in Example 1, except that the coated cathode active material particles were changed as shown in Table 1, then a cathode for lithium-ion batteries and a lithium-ion battery were produced.

### Example 12

### [Production of Coated Cathode Active Material Particles]

1 part of the coating polymer compound was dissolved in 3 parts of DMF to obtain a coating polymer compound solution.

When 87.33 parts of cathode active material particles (LiNi0.8Co_{0.15}Al_{0.05}O₂ powder, volume average particle diameter 4 μm) were put into a Universal Mixer High Speed Mixer FS25 [commercially available from EARTHTECHNICA Co., Ltd.] and stirred at room temperature and 720 rpm, 12.20 parts of the coating polymer compound solution was added dropwise over 2 minutes and additionally stirred for 5 minutes.

Next, in a stirred state, 3.05 parts of acetylene black (Denka Black (registered trademark) manufactured by Denka Co., Ltd.) as a conductive assistant and 5.08 parts of ceramic particles (SiO₂) were added in portions for 2 minutes, and the stirring was continued for 30 minutes.

Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles.

Coated cathode active material particles were produced in the same manner as in Example 1, except that the coated cathode active material particles were changed as shown in Table 1, then a cathode for lithium-ion batteries and a lithium-ion battery were produced.

### Example 13

### [Production of Coated Cathode Active Material Particles]

1 part of the coating polymer compound was dissolved in 3 parts of DMF to obtain a coating polymer compound solution.

When 82.33 parts of cathode active material particles (LiNi0.8Co_{0.15}Al_{0.05}O₂ powder, volume average particle diameter 4 μm) were put into a Universal Mixer High Speed Mixer FS25 [commercially available from EARTHTECHNICA Co., Ltd.] and stirred at room temperature and 720 rpm, 11.56 parts of the coating polymer compound solution was added dropwise over 2 minutes and additionally stirred for 5 minutes.

Next, in a stirred state, 2.89 parts of acetylene black (Denka Black (registered trademark) manufactured by Denka Co., Ltd.) as a conductive assistant and 10.00 parts of ceramic particles (SiO₂) were added in portions for 2 minutes, and the stirring was continued for 30 minutes.

Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles.

Coated cathode active material particles were produced in the same manner as in Example 1, except that the coated cathode active material particles were changed as shown in Table 1, then a cathode for lithium-ion batteries and a lithium-ion battery were produced.

### Example 14

### [Production of Coated Cathode Active Material Particles]

1 part of the coating polymer compound was dissolved in 3 parts of DMF to obtain a coating polymer compound solution.

When 87.33 parts of cathode active material particles (LiNi0.8Co_{0.15}Al_{0.05}O₂ powder, volume average particle diameter 4 μm) were put into a Universal Mixer High Speed Mixer FS25 [commercially available from EARTHTECHNICA Co., Ltd.] and stirred at room temperature and 720 rpm, 12.20 parts of the coating polymer compound solution was added dropwise over 2 minutes and additionally stirred for 5 minutes.

Next, in a stirred state, 3.05 parts of acetylene black (Denka Black (registered trademark) manufactured by Denka Co., Ltd.) as a conductive assistant and 5.08 parts of ceramic particles (AL₂O₃) were added in portions for 2 minutes, and the stirring was continued for 30 minutes.

Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles.

Coated cathode active material particles were produced in the same manner as in Example 1, except that the coated cathode active material particles were changed as shown in Table 1, then a cathode for lithium-ion batteries and a lithium-ion battery were produced.

### Example 15

### [Production of Coated Cathode Active Material Particles]

1 part of the coating polymer compound was dissolved in 3 parts of DMF to obtain a coating polymer compound solution.

When 87.33 parts of cathode active material particles (LiNi0.8Co_{0.15}Al_{0.05}O₂ powder, volume average particle diameter 4 μm) were put into a Universal Mixer High Speed Mixer FS25 [commercially available from EARTHTECHNICA Co., Ltd.] and stirred at room temperature and 720 rpm, 12.20 parts of the coating polymer compound solution was added dropwise over 2 minutes and additionally stirred for 5 minutes.

Next, in a stirred state, 3.05 parts of acetylene black (Denka Black (registered trademark) manufactured by Denka Co., Ltd.) as a conductive assistant and 5.08 parts of ceramic particles (TiO₂) were added in portions for 2 minutes, and the stirring was continued for 30 minutes.

Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles.

Coated cathode active material particles were produced in the same manner as in Example 1, except that the coated cathode active material particles were changed as shown in Table 1, then a cathode for lithium-ion batteries and a lithium-ion battery were produced.

### <Comparison 1>

### [Production of Coated Cathode Active Material Particles]

1 part of the coating polymer compound was dissolved in 3 parts of DMF to obtain a coating polymer compound solution.

When 92.22 parts of cathode active material particles (LiNi0.8Co_{0.15}Al_{0.05}O₂ powder, volume average particle diameter 4 μm) were put into a Universal Mixer High Speed Mixer FS25 [commercially available from EARTHTECHNICA Co., Ltd.] and stirred at room temperature and 720 rpm, 12.56 parts of the coating polymer compound solution was added dropwise over 2 minutes and additionally stirred for 5 minutes.

Next, in a stirred state, 3.14 parts of acetylene black (Denka Black (registered trademark) manufactured by Denka Co., Ltd.) as a conductive assistant was added in portions for 2 minutes, and the stirring was continued for 30 minutes.

Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components.

The obtained powder was classified using a sieve with an opening of 200 μm to prepare coated cathode active material particles.

Coated cathode active material particles were produced in the same manner as in Example 1, except that the coated cathode active material particles were changed as shown in Table 1, then a cathode for lithium-ion batteries and a lithium-ion battery were produced.

### <Comparison 2>

Coated cathode active material particles were produced in the same manner as in Example 1, except that the ceramic particles were changed as shown in Table 1, then a cathode for lithium-ion batteries and a lithium-ion battery were produced.

### <Measurement of Internal Resistance Value>

The lithium-ion batteries obtained in each example and comparison were charged and discharged once at 25° C. Thereafter, it was fully charged and stored in a condition of 60° C.

Using an impedance measuring device (chemical impedance analyzer IM3590, commercially available from HIOKI E.E. Corporation), after 0 days (immediately after full charge), after storage for 7 days, after storage for 14 days, and after storage for 21 days, the internal resistance value at a frequency of 1,100 Hz was measured.

Then, the rate of increase in internal resistance value after storage for 21 days compared to after 0 days <[(internal resistance after storage for 21 days−internal resistance after 0 days)/internal resistance after 0 days)]×100(%)> was calculated.

The results are shown in Table 1.

### <Thickness of Cathode for Lithium-Ion Batteries>

In terms of the lithium-ion batteries obtained in each example and comparison, the thickness of the cathode active material layer for lithium-ion batteries was measured using a digital film thickness meter [Digimatic indicator: ID-C112CXB (manufactured by Mitutoyo Corporation), stand: 7007-10 (manufactured by Mitutoyo Corporation)].

Based on the energy density of the cathode for lithium-ion batteries, it was determined that the thickness of the cathode for lithium-ion batteries was preferably 230 μm or less. The results are shown in Table 1.

TABLE 1

| | Ceramic Particles | | | | | | | | |
|---|---|---|---|---|---|---|---|---|---|
| | | | Addition | | | | | Rate of | |
| | | | amount | | | | | increase | |
| | | | based | | | | | in internal | |
| | | | on weight | | | | | resistance | Thickness |
| | | | of coated | | | | | value | of |
| | | BET | cathode | | | | | after storage | cathode |
| | | Specific | active | Internal Resistance | | | | for 21 days | active |
| | Product | Surface | material | Value (Ω) | | | | compared to | material |
| | Name | Area | particles | Storage Days (day) | | | | after 0 days | layer |
| | (Item) | (m²/g) | (wt %) | 0 | 7 | 14 | 21 | (%) | (μm) |
| Example 1 | SiO₂ | 72.5 | 2.10 | 3.2 | 4.3 | 5.0 | 5.7 | 78.1 | 213 |
| Example 2 | AEROSIL R972 | 110 | 2.10 | 3.0 | 3.9 | 4.6 | 5.2 | 73.3 | 215 |
| Example 3 | REOLOSIL DM-10 | 115 | 2.10 | 3.4 | 4.3 | 5.1 | 6.1 | 78.4 | 216 |
| Example 4 | REOLOSIL MT-10 | 126 | 2.10 | 2.9 | 3.7 | 4.2 | 4.6 | 58.6 | 217 |
| Example 5 | NIPSIL NA | 140 | 2.10 | 3.6 | 4.4 | 5.1 | 5.8 | 61.1 | 213 |
| Example 6 | NIPLSIL NS-T | 160 | 2.10 | 3.4 | 3.9 | 4.5 | 5.0 | 47.1 | 218 |
| Example 7 | AEROSIL R974 | 170 | 2.10 | 3.1 | 3.9 | 4.5 | 5.0 | 61.3 | 214 |
| Example 8 | ULTRASIL VN3 | 170 | 2.10 | 3.3 | 4.0 | 4.8 | 5.5 | 66.7 | 212 |
| Example 9 | AEROSIL 200 | 200 | 2.10 | 3.1 | 3.7 | 4.1 | 4.5 | 45.2 | 216 |
| Example 10 | AEROSIL 300 | 300 | 2.10 | 3.1 | 4.0 | 4.7 | 5.3 | 71 | 218 |
| Example 11 | SiO₂ | 72.5 | 2.00 | 3.2 | 4.3 | 5.0 | 5.7 | 78.1 | 213 |
| Example 12 | SiO₂ | 72.5 | 5.08 | 3.2 | 3.9 | 4.7 | 5.6 | 75 | 223 |
| Example 13 | SiO₂ | 72.5 | 10.00 | 3.3 | 4.3 | 5.2 | 6.0 | 81.8 | 265 |
| Example 14 | Al₂O₂ | 71.2 | 5.08 | 3.6 | 4.6 | 5.6 | 6.6 | 83.8 | 229 |
| Example 15 | TiO₂ | 73.6 | 5.08 | 3.8 | 4.9 | 6.0 | 6.9 | 81.6 | 225 |
| Comparison 1 | No Addition | | | 3.0 | 4.1 | 7.7 | 12.8 | 326.7 | 207 |
| Comparison 2 | AEROSIL 50 | 50 | 2.1 | 3.2 | 5.5 | 7.4 | 9.9 | 209.4 | 212 |

From Table 1, it was observed that the examples in which the coating layer includes ceramic particles having a certain BET specific surface area could prevent the internal resistance value of the lithium-ion battery from increasing.

Further, by comparison of Examples 11 to 13, it was observed that a cathode for lithium-ion batteries with high energy density could be obtained by setting the weight proportion of the ceramic particles within the range of 1.0 to 5.0 wt % based on the weight of the coated cathode active material particles for lithium-ion batteries.

Furthermore, the present invention relates to a cathode for lithium-ion batteries and a lithium-ion battery described below. This cathode for lithium-ion batteries may include the above-described cathode active material particles. This lithium-ion battery may include such a cathode for lithium-ion batteries.

Lithium-ion batteries have come to be widely used in a variety of usages as secondary batteries that can achieve high energy density and high power density. In terms of a typical lithium-ion battery, after a cathode active material layer and an anode active material layer are provided on one side of a current collector respectively, these cathode active material and anode active material are stacked with a separator sandwiched between the active material layers. With this configuration, a substantially flat lithium secondary cell is manufactured and the typical lithium-ion battery comprises a plurality of these cells.

Among the materials comprising lithium-ion batteries, as a separator, which is a member that prevents a short circuit between a cathode and an anode, the separator based on a polyolefin porous membrane is often used from the viewpoint of safety. The porous polyolefin membrane has a function (shutdown function) that increases the battery's internal resistance by melting and closing the pores when the battery suddenly generates heat due to short circuit or overcharging. This can lead to the battery's safety.

On the other hand, since the polyolefin porous membrane, that is the separator base material, forms a porous structure by stretching, it shrinks and deforms (hereinafter also referred to as thermal deformation) when heated above a predetermined temperature (shrinkage temperature). Therefore, the temperature of the separator base material exceeds the above-mentioned shrinkage temperature due to the heat generated by the usage of the battery or the heat applied during battery manufacturing, causing thermal deformation, which may cause an internal short circuit.

As a separator that can prevent internal short circuits due to thermal deformation, the separator, which comprises a separator body and a frame member arranged annularly along the outer periphery of the separator body, is disclosed (refer to Patent Reference 2), wherein the frame member comprises a heat-resistant annular support member and a sealing layer arranged on the surface of the frame member.

The frame member is required to prevent a short circuit between the cathode and the anode, even if the separator is thermally deformed. However, when the frame member described in Patent Reference 2 is used, the peel strength between the frame member and the current collector of the cathode side is reduced, and peeling may easily occur when the temperature rises to a temperature higher than a temperature at which thermal deformation of the separator occurs. The reason for this is thought to be that the electrolyte salt constituting the electrolytic solution is thermally decomposed at high temperatures, thereby changing the inside of the battery into an acidic environment. If peeling occurs between the frame member and the current collector, there is a risk that a short circuit between the cathode and the anode will occur. Therefore, there is a need for a highly reliable frame member that does not cause peeling between the frame member and the current collector, even in abnormal situations such as thermal decomposition of the electrolytic solution.

The present invention has been made in view of the above-mentioned problems and has an objective to provide a cathode for lithium-ion batteries and a lithium-ion battery that can maintain a peel strength between a frame member and a current collector of the cathode side as much as possible, even in abnormal situations such as thermal decomposition of the electrolytic solution, and that are reliable.

The present inventors have reached the present invention as a result of intensive studies to solve the above problems. In other words, this invention relates to a cathode for lithium-ion batteries, comprising: a current collector; a cathode composition having the cathode active material particles, which are mentioned in claim 1, provided on the current collector; and a frame member that is provided on the current collector, and that is circularly arranged so as to surround the cathode composition; wherein the surface energy of the frame member is 35 mN/m or more. Also, this invention relates to a lithium-ion battery that comprises the cathode for lithium-ion batteries.

The cathode for lithium-ion batteries and the lithium-ion battery of this invention can maintain a peel strength between a frame member and a current collector of the cathode side as much as possible, and are reliable.

Hereinafter, this variation will be described in detail. In the present specification, the lithium-ion battery in a case of being described shall include a concept of a lithium-ion secondary battery as well.

### [Cathode for Lithium-Ion Batteries]

The cathode for lithium-ion batteries of this invention, comprising: a current collector; a cathode composition having the cathode active material particles provided on the current collector; and a frame member that is provided on the current collector, and that is circularly arranged so as to surround the cathode composition; wherein the surface energy of the frame member is 35 mN/m or more.

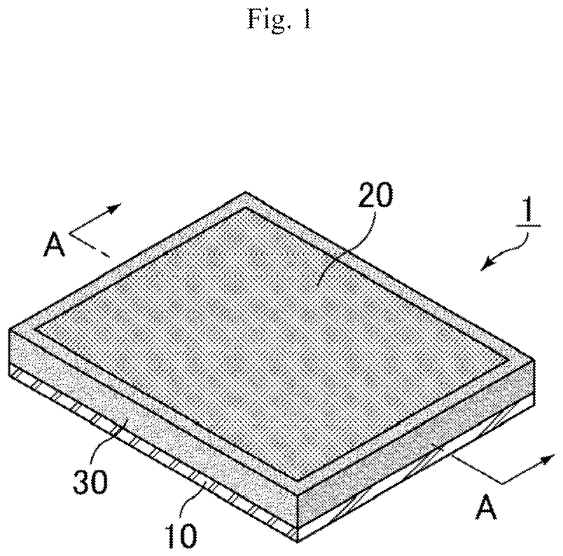

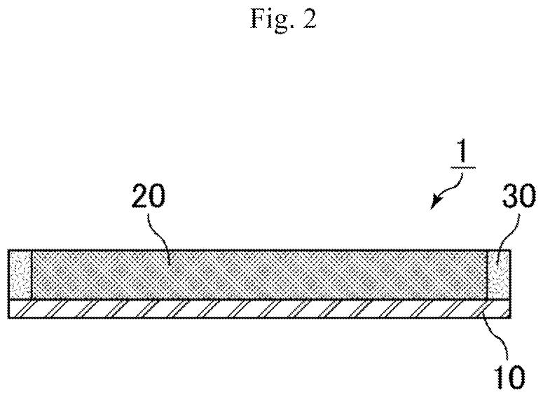

FIG. 1 is a perspective view schematically showing an example of a cathode for lithium-ion batteries according to this invention. FIG. 2 is a cross-sectional view along line A-A shown in FIG. 1.

As shown in FIGS. 1 and 2, the cathode for lithium-ion batteries 1 comprises a current collector 10, a cathode composition 20, and a frame member 30. The cathode composition 20 is placed on the current collector 10. The frame member 30 is placed on the current collector 10 and is circularly arranged so as to surround the cathode composition. The frame member 30 has a square outer shape and an inner shape when viewed from above. The cathode composition 20 is placed inside the frame member 30.

The surface energy of the frame member is 35 mN/m or more. In a case when the surface energy of the frame member is 35 mN/m or more, the peel strength between the frame member and the current collector of the cathode side can be reduced even in abnormal situations such as thermal decomposition of the electrolytic solution. As a result, the peel strength between the frame member and the current collector can be improved. The current collector of the cathode side is also called a cathode current collector.

The surface energy of the frame member can be measured using a dyne pen. Specifically, lines are drawn on the surface of the frame member using multiple dyne pens, and after 2 seconds, it is observed whether the state of the ink on the surface of the frame member has changed (has turned into droplets). Due to this, the surface energy of the frame member can be measured. A plurality of dyne pens have different surface energies of ink filled inside. Among the inks that do not change the state of the ink on the surface of the frame member, 2 seconds after drawing the line, the surface energy of the ink with the largest surface energy becomes the surface energy of the frame member.

The surface energy of the frame member is preferably 40 mN/m or more, more preferably 45 mN/m or more, and particularly preferably 50 mN/m or more. The higher the surface energy of the frame member, the more the peel strength between the frame member and the current collector under acidic conditions, can be improved.

The surface energy of the frame member can be adjusted by adjusting the materials constituting the frame member and the mixing ratio thereof.

It is preferable that the frame member contains polyolefin resin. Polyolefin resin can easily adjust the surface energy of the frame member to 35 mN/m or more. Examples of the polyolefin resin include Mersen (registered trademark) G manufactured by Tosoh Corporation.

The frame member may contain resin other than polyolefin resin. Examples of resins other than polyolefin resins include polyester resins. Examples of the polyester resin include polyethylene naphthalate (PEN) and polyethylene terephthalate (PET). Polyester resin can provide rigidity to the frame member.

The polyester resin constituting the frame member may be used in a mixed state with a polyolefin resin. Or a polyolefin resin molded into a film and a polyester resin molded into a film may be stacked.

In a case when the polyolefin resin molded into a film and the polyester resin molded into a film are stacked, preferably, the polyolefin resin is placed on the outermost side.

An example of this is a frame member that stacks polyolefin resin molded into a film so as to sandwich both sides of a polyester resin molded into a film.

The frame member may comprise a non-conductive filler.

Examples of the non-conductive filler include inorganic fibers such as glass fibers and inorganic particles such as silica particles.

The thickness of the frame member is not particularly limited, but is preferably 0.1 to 10 mm.

The width of the frame member is not particularly limited, but is preferably 5 to 20 mm. If the width of the frame member is less than 5 mm, the mechanical strength of the frame member may be insufficient, and the cathode composition may leak out of the frame member. On the other hand, if the width of the frame member exceeds 20 mm, the area occupied by the cathode composition may decrease, resulting in a decrease in energy density. Herein, the width of the frame member is expressed as the length between the outer shape and the inner shape when the frame member is viewed from above. Depending on the shape of the frame member, it may have a wide portion and a narrow portion.

The cathode composition includes cathode active material particles. The cathode composition contains cathode active material particles, and may also contain a conductive aid, an electrolytic solution, a solution-drying type known binder for electrodes (also referred to as a binder), and an adhesive resin, if necessary.

However, the cathode composition preferably does not contain a known electrode binder, and preferably contains an adhesive resin.

The cathode active material particles include a composite oxide of lithium and a transition metal {a composite oxido having one kind of transition metal (LiCoO₂, LiNiO₂, LiAlMnO₄, LiMnO₂, LiMn₂C₄, or the like), a composite oxide having two kinds of transition metal elements (for example, LiFeMnO4, LiNi₁₋ₓCoₓO₂, LiMn_{1-y}Co_{y}O₂, LiNi_{1/3}Co_{1/3}Al_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1. One example is LiNi_{1/3}Mn_{1/3}Co_{1/3}O₂)], or the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive macromolecule (for example, polyaniline, polypyrrole, polythiophene, polyacetylene, poly-p-phenylene, or polyvinyl carbazole). Also, these cathode active material particles may be used alone. Two or more thereof may be used in combination.

Herein, the lithium-containing transition metal phosphate may have some of the transition metal sites replaced with other transition metals.

The volume average particle size of the cathode active material particles is preferably from 0.01 to 100 μm, more preferably from 0.1 to 35 μm, and even more preferably from 2 to 30 μm, from the viewpoint of electrical characteristics of the battery.

In the present specification, the volume average particle size of the cathode active material means the particle size (Dv50) at an integrated value of 50% in the particle size distribution obtained by the microtrack method (the laser diffraction/scattering method). The microtrack method is a method of determining a particle size distribution by using scattered light obtained by irradiating particles with laser light. Laser diffraction/scattering type particle size distribution measurement device [Microtrack, manufactured by Bell Co., Ltd., etc.] can be used for measuring the volume average particle size.

The conductive assistant is preferably selected from among materials having conductivity.

Specific examples thereof include a metal (nickel, aluminum, stainless steel (SUS), silver, copper, titanium, or the like), carbon [graphite, carbon black (acetylene black, Ketjen black, furnace black, channel black, thermal lamp black, or the like), or the like], and a mixture thereof; however, it is not limited to these.

One kind of these conductive assistants may be used alone, or two or more kinds thereof may be used in combination.

Moreover, an alloy or metal oxide thereof may be used. From the viewpoint of electrical stability, aluminum, stainless steel, carbon, silver, copper, titanium, or a mixture thereof is preferable, silver, aluminum, stainless steel, or carbon is more preferable, and carbon is still more preferable.

Further, these conductive assistants may be those obtained by coating a conductive material (a metallic conductive material among materials of the conductive assistant described above) around a particle-based ceramic material or a resin material with plating or the like.

The average particle size of the conductive assistant is not particularly limited; however, it is preferably 0.01 to 10 μm, more preferably 0.02 to 5 μm, and still more preferably 0.03 to 1 μm, from the viewpoint of the electrical characteristics of the battery. In the present specification, the “particle size” means the maximum distance L among the distances between any two points on the contour line of the conductive assistant. As the value of the “average particle size”, the average value of the particle sizes of the particles observed in several to several tens of visual fields using an observation means such as a scanning electron microscope (SEM) or a transmission electron microscope (TEM) shall be adopted.

The shape (the form) of the conductive assistant is not limited to the particle form, may be a form other than the particle form, and may be a form practically applied as a so-called filler-based conductive resin composition such as carbon nanotubes.

The conductive assistant may be a conductive fiber of which the shape is fibrous.

Examples of the conductive fiber include a carbon fiber such as a PAN-based carbon fibers or a pitch-based carbon fiber, a conductive fiber obtained by uniformly dispersing a metal having good conductivity or graphite in the synthetic fiber, a metal fiber obtained by making a metal such as stainless steel into a fiber, a conductive fiber obtained by coating a surface of an organic fiber with a metal, and a conductive fiber obtained by coating a surface of an organic fiber with a resin containing a conductive substance. Among these conductive fibers, a carbon fiber is preferable. In addition, a polypropylene resin in which graphene is kneaded is also preferable.

In a case where the conductive assistant is a conductive fiber, the average fiber diameter thereof is preferably 0.1 to 20 μm.

The cathode active material particles may be coated cathode active material particles, where at least a part of the surface of the coated cathode active material particles is coated with a coating layer containing polymer compounds.

In a case where the periphery of the cathode active material particles is covered by a coating layer, the changes in volume of the cathode composition due to charging and discharging are alleviated, and thus the expansion of the cathode can be suppressed.

As the macromolecule compound constituting the coating material, those described as the non-aqueous secondary battery active material coating resin in Japanese Unexamined Patent Application, First Publication No. 2017-054703 can be suitably used.

The method of manufacturing the coated cathode active material particles mentioned above will be explained.

For example, the coated cathode active material particles may be produced by mixing a polymer compound, cathode active material particles and a conductive assistant if needed, and by mixing a polymer compound, cathode active material particles and a conductive assistant. In a case when a conductive assistant is applied to a coating layer, the coated cathode active material particles may be produced by mixing the coating material and the electrode active material after preparing the coating material by mixing a polymer compound and a conductive assistant.

Herein, in a case when mixing cathode active material particles, a polymer compound and a conductive assistant, there are no particular restrictions about the order of mixing, but it is preferable that a conductive assistant is further added after mixing cathode active material particles and a polymer compound.

With this method, at least part of the surface of cathode active material particles is coated with a coating layer containing a polymer compound and a conductive assistant if needed.

As the conductive assistant, which is an optional component of the coating material, the same conductive assistant constituting the cathode composition can be suitably used.

As an electrolytic solution, a known electrolytic solution, which is used for manufacturing a lithium-ion battery, including an electrolyte and a non-aqueous solvent can be applicable.

Examples of an electrolytic solution include inorganic acid lithium salt-based electrolytes such as LiPF₆, LiBF₄, LiSbF₆, LiAsF₆, and LiClO₄, sulfonylimide electrolyte containing fluorine atoms such as LiN(FSO₂)₂, LiN(CF₃SO₂)₂ and LiN(C₂F₅SO₂)₂, sulfonylmethide electrolyte with fluorine atom such as and LiC(CF₃SO₂)₃.

Among these, from the viewpoint of battery output and charge/discharge cycle characteristics, LiPF₆ or LiN(FSO₂)₂ is preferred.

As the non-aqueous solvent, a non-aqueous solvent that is used in known electrolytic solutions, or the like can be used, for example, a lactone compound, a cyclic or chain-like carbonic acid ester, a chain-like carboxylic acid ester, a cyclic or chain-like ether, a phosphoric acid ester, a nitrile compound, an amide compound, a sulfone, a sulfolane, or the like, and mixtures thereof can be used.

Examples of the lactone compound may include 5-membered ring (γ-butyrolactone, γ-valerolactone, and the like) and 6-membered ring lactone compounds (6-valerolactone and the like), and the like.

Examples of the cyclic carbonic acid ester include propylene carbonate, ethylene carbonate, butylene carbonate, and the like.

Examples of the chain-like carbonic acid ester include dimethyl carbonate, methylethyl carbonate, diethyl carbonate, methyl-n-propyl carbonate, ethyl-n-propyl carbonate, di-n-propyl carbonate, and the like.

Examples of the chain-like carboxylic acid ester include methyl acetate, ethyl acetate, propyl acetate, methyl propionate, and the like. Examples of the cyclic ether include tetrahydrofuran, tetrahydropyran, 1,3-dioxolane, 1,4-dioxane, and the like. Examples of the chain-like ether include dimethoxymethane, 1,2-dimethoxyethane, and the like.

Examples of the phosphoric acid ester include trimethyl phosphate, triethyl phosphate, ethyldimethyl phosphate, diethylmethyl phosphate, tripropyl phosphate, tributyl phosphate, tri(trifluoromethyl) phosphate, tri(trichloromethyl) phosphate, tri(trifluoroethyl) phosphate, tri(triperfluoroethyl) phosphate, 2-ethoxy-1,3,2-dioxaphospholan-2-one, 2-trifluoroethoxy-1,3,2-dioxaphospholan-2-one, 2-methoxyethoxy-1,3,2-dioxaphospholan-2-one, and the like.

Examples of the nitrile compound include acetonitrile and the like. Examples of the amide compound include DMF and the like.

Examples of the sulfone include dimethylsulfone, diethylsulfone and the like.

The non-aqueous solvent may be used singly or two or more kinds may be used in combination.

Among the non-aqueous solvents, from the viewpoints of battery power output and charge-discharge cycle characteristics, preferred are a lactone compound, a cyclic carbonic acid ester, a chain-like carbonic acid ester, and a phosphoric acid ester. More preferred are a lactone compound, a cyclic carbonic acid ester, and a chain-like carbonic acid ester, and particularly preferred are a mixed liquid of a cyclic carbonic acid ester and a chain-like carbonic acid ester.

Most preferred is a mixed liquid of ethylene carbonate (EC) and dimethyl carbonate (DMC), or a mixed liquid of ethylene carbonate (EC) and diethyl carbonate (DEC).

The known solvent-drying binders for electrodes may be starch, polyvinylidene fluoride (PVdF), polyvinyl alcohol (PVA), carboxymethylcellulose (CMC), polyvinylpyrrolidone (PVP), polytetrafluoroethylene (PTFE), styrene-butadiene rubber (SBR), polyethylene (PE) and polypropylene (PP) etc.

Herein, the content of the known binder for electrodes is preferably 2 wt % or less, more preferably 0 to 0.5 wt %, based on the weight of the entire cathode composition.

It is better for the cathode composition to contain not said known binders for electrodes but an adhesive resin.

In a case when a cathode composition contains said known solvent-drying binders for electrodes, it is necessary to perform a drying process to integrate them after forming the compression molded product. However, in a case when containing the adhesive resin, the cathode composition can be fixed with slight pressure at room temperature without a drying step.

In a case when the drying step is not performed, the compression molded product will not shrink or crack due to heating, which is preferable.

Herein, the solvent-drying binders for electrodes are things that firmly adhere and fix the active materials to one another, wherein the solvent-drying binders are dried and solidified by evaporating the solvent component.

On the other hand, adhesive resin means a resin having stickiness (the property of adhering just by applying a slight pressure without using water, solvent, heat, etc.). The solution-drying type electrode binder is a different material from the adhesive resin.

As the adhesive resin, those described as a mixture of a polymer compound constituting a coating layer (Japanese Unexamined Patent Application, First Publication No. 2017-054703, etc.) and a small amount of organic solvent with adjusting the glass transition temperature below room temperature, and as an adhesive resin mentioned in Japanese Unexamined Patent Application, First Publication No. H10-255805 or the like.

The weight proportion of the adhesive resin contained in the cathode composition is preferably 0 to 2 wt % based on the weight of the cathode composition.

Examples of a material that constitutes the current collector include metal materials such as copper, aluminum, titanium, stainless steel, nickel, and alloys thereof, and conductive polymer, conductive glass, etc.

Further, a resin current collector comprising a conductive assistant and a resin can be applicable.

From the viewpoint of increasing the peel strength between the current collector and the frame member, the current collector is preferably a resin current collector.

The surface energy of the resin current collector is preferably 30 mN/m or more.

The surface energy of the resin current collector can be measured using a dyne pen.

The specific measuring method is the same as that for measuring the surface energy of the frame member.

As a conductive assistant that constitutes the resin current collector, the same material as the conductive assistant contained in the cathode composition can be suitably used.

Examples of the resin that constitutes the resin current collector include polyethylene (PE), polypropylene (PP), polymethylpentene (PMP), polycycloolefin (PCO), polyethylene terephthalate (PET), polyether nitrile (PEN), polytetrafluoroethylene (PTFE), styrene-butadiene rubber (SBR), polyacrylonitrile (PAN), polymethyl acrylate (PMA), polymethyl methacrylate (PMMA), polyvinylidene fluoride (PVdF), an epoxy resin, a silicone resin, mixtures thereof, and the like.

From the viewpoint of electrical stability, polyethylene (PE), polypropylene (PP), polymethylpentene (PMP), and polycycloolefin (PCO) are preferred, and polyethylene (PE), polypropylene (PP), and polymethylpentene (PMP) are more preferred.

In a case when the cathode for lithium-ion batteries is viewed from above, the ratio of the area of the frame member to the area of the current collector (that is, the area of the portion where the frame member and the current collector are bonded) is preferably 8.5 area % or more and 45.2 area % or less.

In terms of the cathode for lithium-ion batteries of the present invention, the frame member and the current collector are bonded to each other.

The peel strength between the frame member and the current collector is preferably 1.3 N/cm or more after being immersed in an electrolytic solution at 25° C. for 6 days.

The peel strength between the frame member and the current collector after being immersed in an electrolytic solution at 72° C. for 6 days is preferably 1.0 N/cm or more, and more preferably 1.3 N/cm or more, and even more preferably 1.5 N/cm or more.

If the peel strength between the frame member and the current collector is 1.0 N/cm or more after being immersed in an electrolytic solution at 72° C. for 6 days, the peel strength between the frame member and the current collector under high temperature conditions is sufficient.

The electrolytic solution used to measure peel strength was prepared by dissolving LiN(FSO₂)₂ at a ratio of 1.0 mol/L in a mixed solvent of ethylene carbonate (EC) and propylene carbonate (PC) (volume ratio 1:1).

The peel strength between the frame member and the current collector can be measured in accordance with JIS K 6854-2:1999 except for changing the shape of the test piece for measuring detachment strength to 65 mm in length and 20 mm in width, and changing the grip movement speed to 60 mm/min.

In terms of the cathode for lithium-ion batteries of the present invention, the peel strength between the frame member and the current collector, which was measured after the T2 test of UN (United Nations) recommended transport test UN38.3, is preferably 1.3 N/cm or more.

In addition, in the T2 test of UN Recommended Transport Test UN38.3, holding at 75° C. for 6 hours and holding at −40° C. for 6 hours is repeated 10 times in total at 10 minutes intervals.

The cathode for lithium-ion batteries of the present invention can be produced, for example, by arranging a frame member on a current collector and filling the inside of the frame member with a cathode active material. The current collector and the frame member are bonded together by means, such as heat sealing.

### [Lithium-Ion Battery]

The lithium-ion battery of the present invention is characterized by comprising the cathode for lithium-ion batteries of the present invention.

Since the lithium-ion battery of the present invention comprises the cathode for lithium-ion batteries of the present invention, the lithium-ion battery can maintain a peel strength between a frame member and a current collector of the cathode side as much as possible, even in abnormal situations such as thermal decomposition of the electrolytic solution, and is reliable.

The lithium-ion battery of the present invention can be produced, for example, by combining the cathode for lithium-ion batteries of the present invention with an anode for lithium-ion batteries via a separator.

Hereinafter, a current collector constituting a cathode for lithium-ion batteries will be distinguished from a cathode current collector, and a current collector constituting an anode for lithium-ion batteries will be distinguished from an anode current collector.

An anode for lithium-ion batteries comprises an anode current collector and an anode composition containing anode active material particles disposed on the anode current collector.

The anode composition includes anode active material particles.

As the anode active material particles, known anode active material particles used in lithium-ion batteries can be used.

As the anode current collector, a known current collector used for an anode for lithium-ion batteries can be used.

The anode for lithium-ion batteries may comprise a frame member that is provided on the anode current collector, and that is circularly arranged so as to surround the anode composition.

The anode composition may contain a conductive assistant and an electrolytic solution.

As the conductive assistant and the electrolytic solution, the same conductive assistant and electrolytic solution as used in the cathode for lithium-ion batteries of the present invention, can be suitably used.

The anode active material particles may be coated with anode active material particles, where at least a part of the surface of the coated anode active material particles is coated with a coating layer containing a polymer compound.

As a coating agent, the same coating agent constituting the coated cathode active material particles, can be suitably used.

### EXAMPLES

Next, the present invention will be described in detail with reference to examples, but the present invention is not limited to the examples as long as it does not depart from the spirit of the present invention. Here, unless otherwise specified, parts means parts by weight, and % means wt %.

### Production Example 1: Preparation of Coating Polymer Compound and its Solution

407.9 parts of DMF was placed in a four-necked flask equipped with a stirrer, a thermometer, a reflux condenser, a dropping funnel, and a nitrogen gas introduction tube, and the temperature was raised to 75° C. Next, a monomer blending solution obtained by blending 242.8 parts of butyl methacrylate, 97.1 parts of methyl methacrylate, 242.8 parts of 2-ethylhexyl methacrylate and 116.5 parts of DMF, an initiator solution in which 1.7 parts of 2,2′-azobis(2,4-dimethylvaleronitrile) and 4.7 parts of 2,2′-azobis(2-methylbutyronitrile) were dissolved in 58.3 parts of DMF were continuously added dropwise to the four-necked flask over 2 hours under stirring by using a dropping funnel, while blowing nitrogen thereinto, to carry out radical polymerization. After the dropwise addition was completed, the reaction was continued at 75° C. for 3 hours. Next, the temperature was raised to 80° C. and the reaction was continued for 3 hours to obtain a copolymer solution with a resin concentration 50%. 789.8 parts of DMF was added to this to obtain a coating polymer compound solution having a resin solid content concentration of 30 wt %.

### Production Example 2: Preparation of Electrolytic Solution

The electrolytic solution was prepared by dissolving LiN(FSO₂)₂ at a proportion of 1.0 mol/L in a solvent mixture containing ethylene carbonate (EC) and propylene carbonate (PC) (volume ratio of 1:1).

### Production Example 3: Preparation of Coated Cathode Active Material Particles

When 93.7 parts of cathode active material particles (LiNi0.8Co_{0.15}Al_{0.05}O₂ powder, volume average particle diameter 4 μm) were put into a Universal Mixer High Speed Mixer FS25 [commercially available from EARTHTECHNICA Co., Ltd.] and stirred at room temperature and 720 rpm, 1 part of the coating polymer compound solution, which was obtained in the production example 1, was added dropwise over 2 minutes and additionally stirred for 5 minutes.

Next, in a stirred state, 1 part of acetylene black (Denka Black (registered trademark) manufactured by Denka Co., Ltd.) as a conductive assistant was added in portions for 2 minutes, and the stirring was continued for 30 minutes. Thereafter, the pressure was reduced to 0.01 MPa while stirring was maintained, and then the temperature was raised to 140° C. while maintaining stirring and the reduced degree of pressure. And stirring, vacuum and temperature were maintained for 8 hours to distill off volatile components. The obtained powder was classified using a sieve with an opening of 212 μm to prepare coated cathode active material particles.

### Production Example 4: Preparation of Coated Anode Active Material Particles

100 parts of non-graphitizable carbon powder [Carbotron (registered trademark) PS (F) manufactured by Kureha Battery Materials Japan Co., Ltd.], which is an anode active material particle, was placed in an all-purpose mixer, High Speed Mixer FS25 [manufactured by EARTHTECHNICA Co., Ltd.], and at room temperature and in a state of the powder being stirred at 720 rpm, 6 parts of a coating polymer compound obtained in the production example 1 was added dropwise over 2 minutes, and then the resultant mixture was further stirred for 5 minutes. Next, in a state of the resultant mixture being stirred, 5.1 parts of acetylene black [DENKA BLACK (registered trademark) manufactured by Denka Company Limited], which is a conductive assistant, was divisionally added in 2 minutes, and stirring was continued for 30 minutes. Thereafter, the pressure was reduced to 0.01 MPa while stirring was maintained, and then the temperature was raised to 150° C. while maintaining stirring and the reduced degree of pressure. And the stir, vacuum and temperature were maintained for 8 hours to distill off volatile components. The obtained powder was classified using a sieve with an opening of 212 μm to prepare coated anode active material particles.

### Production Example 5: Preparation of Cathode Resin Current Collector

46 parts of block polypropylene [polyolefin resin, product name “SunAllomer PC684S”, manufactured by Sunallomer Co., Ltd.], 21 parts of block polypropylene [polyolefin resin, product name “Sunallomer PC630S”, manufactured by Sunallomer Co., Ltd.], 28 parts of furnace black [conductive filler], product name “#3030B”, manufactured by Mitsui Chemicals, Inc.], and 5 parts of dispersant [trade name “UMEX 1001”, manufactured by Sanyo Chemical Industries, Ltd.] were melt-kneaded using a twin-screw extruder under conditions of 200° C. and 200 rpm to obtain a cathode resin current collector material.

The obtained cathode resin current collector material was passed through a T-die extrusion film forming machine and stretched and rolled to obtain a conductive film for a cathode resin current collector having a film thickness of 100 μm.

Next, the obtained conductive film for a cathode resin current collector was cut into 17.0 cm×17.0 cm. After that, a cathode resin current collector, to which a current extraction terminal (5 mm×3 cm) was connected, was then obtained.

The surface energy of the obtained cathode resin current collector was measured with a Dyne Pen (manufactured by Kasuga Denki Co., Ltd.) and was found to be 34 mN/m.

### Production Example 6: Preparation of Anode Resin Current Collector

28 parts of block polypropylene [polyolefin resin, product name “SunAllomer PC684S”, manufactured by Sunallomer Co., Ltd.], 67 parts of nickel powder [conductive filler, nickel powder Type 255, manufactured by Vale Japan Co., Ltd.] and 5 parts of dispersant [product name “Umex 1001”, manufactured by Sanyo Chemical Industries, Ltd.] were melt-kneaded using a twin-screw extruder under conditions of 200° C. and 200 rpm to obtain an anode resin current collector material.

The obtained anode resin current collector material was passed through a T-die extrusion film forming machine and stretched and rolled to obtain a conductive film for an anode resin current collector having a film thickness of 100 μm.

Next, the obtained conductive film for an anode resin current collector was cut into 17.0 cm×17.0 cm. After that, a cathode resin current collector, to which a current extraction terminal (5 mm×3 cm) was connected, was then obtained.

### Production Example 7: Preparation of Frame Member (F-1)

A resin (Mersene (registered trademark) G manufactured by Tosoh Corporation) was molded into a film having a thickness of 400 μm by extrusion molding. Then a frame member (F-1) was obtained by punching out an annular shape having a square inner diameter of 11.0 cm×11.0 cm and an outer diameter of a square 15.0 cm×15.0 cm.

The surface energy of the obtained frame member (F-1) was measured using a dyne pen. The results are shown in Table 2.

### Production Examples 8 to 10: Production of Frame Members (F-2) to (F-4)

Frame members (F-2) to (F-4) were produced in the same manner as Production Example 7, except that the type of resin used was changed as shown in Table 2, and the surface energy was measured. The thickness of frame members (F-2) to (F-4) is 400 μm, which is the same as (F-1). Herein, the Admar was Admar VE300 manufactured by Mitsui Chemicals, Inc., and the PEN-Mersene was made by sandwiching both sides of a PEN film (250 μm thick) between Mersen films having a thickness of 75 μm and bonding them by thermocompression. PEN-ADMER is made by sandwiching both sides of a PEN film (250 μm thick) with 50 μm thick Admer films (2 sheets on the cathode side and 1 sheet on the anode side) and bonding them by thermocompression. Therefore, PEN-mersene has the same surface energy as Mersene, and PEN-admer has the same surface energy as admer.

### Example 21: Preparation of Cathode for Lithium-Ion Batteries

95 parts of the coated cathode active material particles prepared in Production Example 3, 5 parts of acetylene black as a conductive assistant, and 30 parts of the electrolytic solution prepared in Production Example 2 were mixed to produce a cathode composition.

Subsequently, the frame member (F-1) produced in Production Example 7 was placed on the cathode resin current collector (17.0 cm×17.0 cm) produced in Production Example 5. Then, after heat-sealing the frame member (F-1) and the cathode resin current collector at 120° C., the cathode composition is filled inside the cathode frame member to form a cathode for lithium-ion batteries (C-1).

### Example 22, Comparisons 21-22

Cathodes for lithium-ion battery (C-2), (C′-1) and (C′-2) were manufactured in the same manner as in Example 21, except that the frame member (F-1) was changed to the frame members (F-2) to (F-4) produced in Production Examples 8 to 10.

### <Preparation of Test Piece for Peel Strength Measurement>

Prior to the measurement of peel strength, a test piece for measuring peel strength was prepared according to the following procedure.

First, a test film obtained by punching out the film used to make the frame member (F-1) into a rectangular shape with a length of 65 mm and a width of 20 mm and a test cathode resin current collector obtained by punching out the conductive film for a cathode resin current collector used to produce the cathode resin current collector in Production Example 5 into a rectangular shape with a length of 265 mm and a width of 20 mm, were prepared. Next, one end of the test film in the length direction and one end of the test cathode resin current collector in the length direction were aligned so as to overlap. Then, a test piece (dry) for measuring peel strength according to Example 21 was prepared by heating and thermocompressing a portion of 65 mm in length and 20 mm in width where the test film and test cathode resin current collector overlap at 120° C. using a heat seal tester.

The thermocompression-bonded portion of the test piece for peel strength measurement (dry) was immersed in the electrolytic solution obtained in Production Example 2 and left in a constant temperature bath at 25° C. or 72° C. for 6 days. And then, a test piece for measuring peel strength (immersed at 25° C.) and a test piece for measuring peel strength (immersed at 72° C.) were prepared by taking out and wiping the electrolytic solution on the surface with a Kim towel. Test pieces for peel strength measurement according to Example 22 and Comparisons 21 to 22 were prepared by changing the type of frame member to (F-2) to (F-4), respectively.

### <Measurement of Peel Strength>

Regarding the three types of peel strength measurement test pieces prepared for each example and each comparison, the peel strength can be measured in accordance with JIS K 6854-2:1999 except for changing the adhesive part to 65 mm in length and 20 mm in width, and changing the peel length when measuring peel strength to 50 mm excluding the first 10 mm and the last 5 mm, and changing the grip movement speed to 60 mm/min. In this case, the frame member side of the test piece for peel strength measurement was fixed to a test flat plate with an adhesive, and the cathode resin current collector was pulled as a flexible adherend material. The results are shown in Table 2.

TABLE 2

| | Frame Member | | | | | |
|---|---|---|---|---|---|---|
| | | | Surface | Peel Strength [N/cm] | | |
| | | | Energy | | 25° C. | 72° C. |
| | Type | Resin | [mN/m] | Dry | immersion | immersion |
| Example 21 | F-1 | MERSEN | 50 | 1.94 | 1.49 | 1.81 |
| Example 22 | F-2 | PEN- | 50 | 1.91 | 1.63 | 1.54 |
| | | MERSEN | | | | |
| Comparison | F-3 | PEN- | 30 | 2.45 | 1.46 | 0.69 |
| 21 | | ADMER | | | | |
| Comparison | F-4 | ADMER | 30 | 2.09 | 1.17 | 0.64 |
| 22 | | | | | | |

According to Table 2, it was found that the cathode for lithium-ion batteries of the present invention can maintain the peel strength between the frame member and the current collector, even in a high temperature environment (72° C. immersion).

### Production Example 11: Preparation of Anode for Lithium-Ion Batteries

99 parts of the coated anode active material particles prepared in Production Example 4, 1 part of acetylene black as a conductive assistant, and 30 parts of the electrolytic solution prepared in Production Example 2, were mixed to prepare an anode composition.

Subsequently, the frame member (F-1) produced in Production Example 6 was placed on the anode resin current collector produced in Production Example 6. Then, after heat-sealing the frame member (F-1) and the anode resin current collector at 120° C., the anode composition is filled inside the frame member (F-1) to form an anode for lithium-ion batteries (A-1).

### Example 23: Production of Lithium-Ion Battery

A flat plate-shaped Celgard 3501 (made of PP, thickness 25 μm, dimensions 17.0 cm×17.0 cm in plane view), which will serve as a separator, is placed on top of the cathode for lithium-ion batteries (C-1) prepared in Example 21 so as to cover the cathode composition. It was observed that the electrolytic solution in the cathode composition permeated into the separator and the separator had stuck to the cathode composition. Subsequently, the separator and the cathode for lithium-ion batteries (C-1) were turned over and placed on the anode for lithium-ion batteries (A-1) produced in Production Example 11 so as to touch the separator with the anode composition. Herein, the laminate was produced such that the center of gravity of the external shape of the frame member on the cathode side, the center of gravity based on the external shape of the separator, and the center of gravity of the external shape of the frame member on the anode side, were overlapped with each other along the stacking direction.

Subsequently, the laminate was heated at 120° C. using a heat seal tester. And the separator was thermocompression bonded to the frame member on the cathode side and the frame member on the anode side respectively and was housed in the exterior body. Due to this, a lithium-ion battery according to Example 23, was produced.

### <Comparison 23>

An anode for a lithium-ion batteries (A′-1) was produced in the same manner as in Production Example 11, except that the frame member (F-3) was used instead of the frame member (F-1). Subsequently, a lithium-ion battery according to Comparison 23 was produced in the same manner as in Example 23, except that the cathode for lithium-ion batteries (C′-2) manufactured in Comparison 22 was used instead of the cathode for lithium-ion batteries (C-1) manufactured in Example 21, and the anode for lithium-ion batteries (A′-1) was used instead of the anode for lithium-ion batteries (A-1).

### <Measurement of Capacity Retention Rate>

The lithium-ion batteries according to Example 23 and Comparison 23, were charged (cutoff current: 3.8 mA) at 0.1 C (3.8 mA) to 4.2 V at constant current-constant voltage, and then discharged at 0.1 C (3.8 mA) to 2.5 V at constant current. After discharging, they were charged at constant current-constant voltage to 4.2V at 0.1C (3.8 mA) (cutoff current: 3.8 mA), and the lithium-ion batteries were kept in a constant temperature bath at 72° C. for 6 days. And it was discharged at 0.1 C (3.8 mA) to 2.5 V at constant current. The capacity retention rate [%] was obtained by dividing the discharge capacity after standing at 72° C. for 6 days by the discharge capacity before standing. The results are shown in Table 3.

### <Measurement of Temperature Characteristics>

The lithium-ion batteries according to Example 23 and Comparison 23 were placed in a constant temperature bath at 75° C. and allowed to stand for 6 hours, and then transferred to a constant temperature bath at −40° C. and left for about 6 hours. A temperature change test was conducted in which this process was repeated 10 times at 10 minute intervals. The voltage drop rate was determined from the discharge voltage of the lithium-ion battery before and after the temperature change test. Furthermore, after the temperature change test (presence or absence of liquid leakage), the appearance was visually observed. Then the exterior body was removed and the cathode current collector and the frame member, that constituted the cathode for lithium-ion batteries, were checked whether they had peeled off or not.

Next, the cathode for lithium-ion batteries was taken out from the lithium-ion battery after conducting the temperature change test. A test piece for peel test measurement was prepared by cutting out a part of the portion where the cathode resin current collector and the frame member were not peeled off, and a peel test was conducted. The results are shown in Table 3.

It is noted that in Comparison 23, peeling occurred between the current collector and the frame member that constitute the cathode for lithium-ion batteries. Therefore, this peeling is considered to be the reason of liquid leakage.

TABLE 3

| | Lithium-ion Battery | | Capacity | Temperature characteristics | | |
|---|---|---|---|---|---|---|
| | Cathode | Anode | retention | Voltage | Appearance | Peel |
| | for lithium- | for lithium- | rate | drop rate | (Leakage) | Strength |
| | ion batteries | ion batteries | [%] | [%] | — | [N/cm] |
| Example 23 | C-1 | A-1 | 73.1 | 1.56 | Absence | 1.49 |
| Comparison 23 | C′-2 | A′-1 | 70.9 | 4.58 | Presence | 0.86 |

From the results in Table 3, it was found that the lithium-ion battery having the cathode for lithium-ion batteries of the present invention had a high capacity retention rate. It was also found that the battery is less likely to leak, even when suffered sudden temperature changes. This is thought to be because the peel strength between the cathode resin current collector and the frame member did not decrease even when exposed to rapid temperature changes or high-temperature conditions.

As mentioned above, the cathode for lithium-ion batteries and the lithium-ion battery of this invention can maintain a peel strength between a frame member and a current collector of the cathode side as much as possible, even in abnormal situations such as thermal decomposition of the electrolytic solution, and are reliable.

### INDUSTRIAL APPLICABILITY

The coated cathode active material particles for lithium-ion batteries of this invention are available as a cathode active material for lithium-ion batteries used for mobile phones, personal computers, hybrid vehicles, and electric vehicles. The cathode for lithium-ion batteries of this invention is available as a cathode for bipolar secondary batteries, lithium-ion secondary batteries, etc., which are used for mobile phones, personal computers, hybrid vehicles, and electric vehicles. The lithium-ion battery of this invention is available as a bipolar secondary batteries and lithium-ion secondary batteries, which are used for mobile phones, personal computers, hybrid vehicles, and electric vehicles.

### REFERENCE SIGNS LIST

1: cathode for lithium-ion batteries
10: current collector (cathode current collector)
20: cathode composition
30: frame member

1. Coated cathode active material particles for lithium-ion batteries in which at least a part of the surface of the cathode active material particles is coated with a coating layer,
wherein the coating layer contains a polymer compound, a conductive assistant, and ceramic particles, and
wherein the BET specific surface area of the ceramic particles is 70 to 300 m²/g.

2. The coated cathode active material particles for lithium-ion batteries according to claim 1,
wherein the ceramic particles are SiO₂.

3. The coated cathode active material particles for lithium-ion batteries according to claim 1,
wherein the weight proportion of the ceramic particles is 1.0 to 5.0 wt % based on the weight of the coated cathode active material particles for lithium-ion batteries.

4. A cathode for lithium-ion batteries comprising the coated cathode active material particles for lithium-ion batteries according to claim 1 and a cathode active material layer with an electrolytic solution containing an electrolyte and a solvent,
wherein the cathode active material layer consists of a non-bound component of the coated cathode active material particles for lithium-ion batteries.

5. A method of producing coated cathode active material particles for lithium-ion batteries,
wherein the coated cathode material particles for lithium-ion batteries are mentioned in claim 1,
the method including:
a step of removing a solvent after mixing cathode active material particles, a polymer compound, a conductive assistant, ceramic particles, and an organic solvent.

6. A cathode for lithium-ion batteries, comprising:
a current collector;
a cathode composition having the cathode active material particles, which are mentioned in claim 1, provided on the current collector; and
a frame member that is provided on the current collector, and that is circularly arranged so as to surround the cathode composition,
wherein the surface energy of the frame member is 35 mN/m or more.

7. The cathode for lithium-ion batteries according to claim 6,
wherein at least a part of the surface of the cathode active material particles is coated with a resin layer containing a polymer compound.

8. The cathode for lithium-ion batteries according to claim 6, wherein the current collector is a resin current collector, and
wherein the surface energy of the resin current collector is 30 mN/n or more.

9. A lithium-ion battery, comprising the cathode for lithium-ion batteries according to claim 6.
